(19) United States
(12) Patent Application Publication
(10) Pub. No.: US 2020/0126466 A1
(43) Pub. Date: Apr. 23, 2020

(54) DISPLAY DEVICE

(71) Applicant: SHARP KABUSHIKI KAISHA, Sakai City, Osaka (JP)

(72) Inventors: KOHEI HOSOYACHI, Sakai City, Osaka (JP); SHIGE FURUTA, Sakai City, Osaka (JP); HIDEKAZU YAMANAKA, Sakai City, Osaka (JP); YUHICHIROH MURAKAMI, Sakai City, Osaka (JP)

(21) Appl. No.: 16/620,473

(22) PCT Filed: Jun. 8, 2018
(86) PCT No.: PCT/JP2018/021989

§ 371 Date: Dec. 6, 2019

(30) Foreign Application Priority Data
Jun. 16, 2017 (JP) 2017-118432

(51) Int. Cl. G09G 3/20

(52) U.S. Cl. CPC G09G 3/20; G09G 2310/08; G09G 2310/0286; G09G 2310/0208; G09G 2300/0408

(57) ABSTRACT

On a panel substrate, there are a wide region where the wiring pitch between gate bus lines is relatively wide and a narrow region where the wiring pitch between the gate bus lines is relatively narrow. A shift register operates based on a gate start pulse signal and gate clock signals whose pulse widths are set to N (N is an integer not less than two) times a length of one horizontal scan period. A generation period of a pulse of a gate clock signal that brings one gate bus line constituting a gate bus line pair (two adjacent gate bus lines) into a selected state and a generation period of a pulse of a gate clock signal that brings the other gate bus line constituting the gate bus line pair into the selected state overlap for at least one horizontal scanning period.

### TECHNICAL FIELD

The following disclosure relates to a display device, and more particularly to a display device having a non-rectangular display region.

### BACKGROUND ART

Conventionally, there is known a liquid crystal display device having a display region (a display portion) including a plurality of source bus lines (video signal lines) and a plurality of gate bus lines (scanning signal lines). In such a liquid crystal display device, pixel formation portions that form pixels are provided at intersections of the source bus lines and the gate bus lines. Each pixel formation portion includes a thin film transistor (pixel TFT) which is a switching element connected at its gate terminal to a gate bus line passing through a corresponding intersection and connected at its source terminal to a source bus line passing through the intersection, a pixel capacitance for holding a pixel voltage value, etc. The liquid crystal display device is also provided with a gate driver (scanning signal line drive circuit) for driving the gate bus lines and a source driver (video signal line drive circuit) for driving the source bus lines.

A video signal indicating a pixel voltage value is transmitted by a source bus line. However, each source bus line cannot transmit video signals indicating pixel voltage values for a plurality of rows, at one time (simultaneously). Due to this, writing (charging) of video signals to the pixel capacitances in the plurality of pixel formation portions provided in the display portion is sequentially performed row by row. Hence, in order to sequentially select the plurality of gate bus lines for a predetermined period, the gate driver is composed of a shift register including a plurality of stages. By sequentially outputting active scanning signals (scanning signals with a voltage level that brings the pixel TFTs into the ON state) from the respective stages of the shift register, writing of video signals to the pixel capacitances is sequentially performed row by row as described above. Note that in this specification a circuit that forms each stage of the shift register is referred to as a “unit circuit”.

In the meantime, a conventional general liquid crystal display device has a rectangular display region. However, in recent years, development of a liquid crystal display device including a display region having a shape other than rectangle, such as a liquid crystal display device for timepiece use and a liquid crystal display device for on-vehicle use, has been progressing. Such a display device is called an “oddly shaped display”. As an example of the oddly shaped display, a display device including a display region and a panel substrate which have a concave shape as shown in FIG. 29 is exemplified. In such a display device, some gate bus lines GL are arranged so as to bypass a concave part. Hereinafter, a region where gate bus lines GL are arranged so as to bypass the concave part in this manner (a region given reference character 9 in FIG. 29) is referred to as a “bypass wiring region”. In the oddly shaped display, conventionally, achieving a narrow frame is tried by providing such a bypass wiring region. It should be noted that Japanese Laid-Open Patent Publication No. 2008-257191 discloses an example in which the bypass wiring region is provided, regarding a display device for wristwatch use.

### PRIOR ART DOCUMENT

### Patent Document

[Patent Document 1] Japanese Laid-Open Patent Publication No. 2008-257191

### SUMMARY OF THE INVENTION

### Problems to be Solved by the Invention

However, as grasped from FIG. 29, the wiring pitch between adjacent gate bus lines GL in the bypass wiring region 9 is narrower than that in the other region. Therefore, the coupling capacitance between the gate bus lines GL is large in the bypass wiring region 9. As a result, due to the presence of the coupling capacitance, in each gate bus line GL, coupling noise occurs when a potential of an adjacent gate bus line GL varies.

An effect of the above-described coupling noise will be described with reference to FIG. 30. FIG. 30 shows waveforms of scanning signals supplied to the gate bus lines GL(1) to GL(4) of the first to fourth rows. Each of portions indicated by reference character 90 in FIG. 30 is a portion in which coupling noise caused by rising of the scanning signal for the next row occurs. Conventionally, in general, after falling of the scanning signal for one row, the scanning signal for the next row rises. Accordingly, in each gate bus line GL in the bypass wiring region 9, after falling of the scanning signal, coupling noise caused by rising of the scanning signal for the next row occurs. Since such coupling noise occurs, in a period during which a potential of the scanning signal is maintained at the low level, the potential of the scanning signal rises temporarily. As a result, to the pixel capacitance of each row, writing is performed based on the video signal for the next row, and therefore display defect occurs. It should be noted that coupling noise is not considered in the display device disclosed in Japanese Laid-Open Patent Publication No. 2008-257191.

An object of the following disclosure is therefore to realize a display device capable of suppressing occurrence of display defect due to coupling noise even when there is a region where the wiring pitch between adjacent gate bus lines GL is narrow (for example, the bypass wiring region).

### Means for Solving the Problems

Display devices according to several embodiments are each a display device including a panel substrate on which a display region in which a plurality of scanning signal lines are arranged and a scanning signal line drive circuit configured to drive the plurality of scanning signal lines based on a scan start signal and a plurality of clock signals are formed, the scanning signal line drive circuit being configured by one or more shift register including a plurality of unit circuits. When two adjacent scanning signal lines are defined as a scanning signal line pair, there are a wide region and a narrow region on the panel substrate, the wide region being a region where wiring interval between two scanning signal lines constituting the scanning signal line pair is relatively wide, and the narrow region being a region where wiring interval between two scanning signal lines constituting the scanning signal line pair is relatively narrow. Each of a pulse width of the scan start signal and a pulse width of the plurality of clock signals corresponds to N (N is an integer not less than two) times a length of one horizontal scanning period. A generation period of a pulse of a clock signal supplied to a unit circuit corresponding to one scanning signal line constituting the scanning signal line pair in order to bring the scanning signal line concerned into a selected state and a generation period of a pulse of a clock signal supplied to a unit circuit corresponding to the other scanning signal line constituting the scanning signal line pair in order to bring the scanning signal line concerned into the selected state overlap for at least one horizontal scanning period.

### EFFECTS OF THE INVENTION

According to such a configuration, when focusing on the scanning signal line pair arranged in the narrow region, in a period during which a scanning signal supplied to one scanning signal line is maintained at the ON level, a scanning signal supplied to the other scanning signal line changes from the OFF level to the ON level. Thus, in each scanning signal line, coupling noise occurs in a period during which the scanning signal is maintained at the ON level. Accordingly, even when coupling noise occurs, writing to the pixel capacitance is performed based on a desired video signal. Further, in each scanning signal line, after falling of the scanning signal, there is no influence of rising of the scanning signal for the adjacent row. From the above, in the display device having a region where wiring interval between adjacent scanning signal lines is narrow, occurrence of display defect due to coupling noise is suppressed.

### BRIEF DESCRIPTION OF THE DRAWINGS

FIG. 1 is a diagram for describing a feature common to all embodiments.

FIG. 2 is a block diagram showing a functional configuration of a liquid crystal display device in all embodiments.

FIG. 3 is a circuit diagram showing a configuration of one pixel formation portion.

FIG. 4 is a block diagram showing a schematic configuration of a shift register for a case in which two-phase gate clock signals are used.

FIG. 5 is a block diagram showing a schematic configuration of a shift register for a case in which four-phase gate clock signals are used.

FIG. 6 is a circuit diagram showing one example of a configuration of a unit circuit constituting the shift register.

FIG. 7 is a signal waveform diagram for describing an operation of the unit circuit of the n-th stage.

FIG. 8 is a signal waveform diagram showing waveforms of scanning signals for a case in which two-phase gate clock signals are used.

FIG. 9 is a signal waveform diagram showing waveforms of scanning signals for a case in which four-phase gate clock signals are used.

FIG. 10 is a diagram showing a configuration of main part of a liquid crystal display device according to a first embodiment.

FIG. 11 is a signal waveform diagram for describing a driving method in the first embodiment.

FIG. 12 is a signal waveform diagram for describing an advantageous effect in the first embodiment.

FIG. 13 is a diagram showing a configuration of main part of a liquid crystal display device according to a second embodiment.

FIG. 14 is a diagram showing a general wiring structure of gate bus lines, etc.

FIG. 15 is a diagram showing a wiring structure of gate bus lines, etc. in the second embodiment.

FIG. 16 is a diagram showing a configuration of main part of a liquid crystal display device according to a third embodiment.

FIG. 17 is a diagram showing a configuration of main part of a liquid crystal display device according to a fourth embodiment.

FIG. 18 is a signal waveform diagram for describing a driving method in the fourth embodiment.

FIG. 19 is a signal waveform diagram for describing a case in which the same driving method as conventional one is adopted, in order to compare with the fourth embodiment.

FIG. 20 is a signal waveform diagram for describing an occurrence of coupling noise for a case in which the same driving method as conventional one is adopted, in order to compare with the fourth embodiment.

FIG. 21 is a signal waveform diagram for describing an advantageous effect in the fourth embodiment.

FIG. 22 is a diagram for describing an advantageous effect in the fourth embodiment.

FIG. 23 is a diagram for describing an advantageous effect in the fourth embodiment.

FIG. 24 is a diagram showing a configuration of main part of a liquid crystal display device according to a fifth embodiment.

FIG. 25 is a signal waveform diagram for describing an occurrence of coupling noise for a case in which the same driving method as conventional one is adopted, in order to compare with the fifth embodiment.

FIG. 26 is a diagram for describing an advantageous effect in the fifth embodiment.

FIG. 27 is a diagram showing a configuration of main part of a liquid crystal display device for a case in which a shift register is provided at only one end side of a display region.

FIG. 28 is a diagram showing a configuration of main part of a liquid crystal display device for a case in which all gate bus lines are driven from both end sides of a display region.

FIG. 29 is a diagram for describing a display device including a display region and a panel substrate which have a concave shape regarding a conventional example.

FIG. 30 is a signal waveform diagram for describing an effect of coupling noise regarding a conventional example.

### MODES FOR CARRYING OUT THE INVENTION

### 0. Preface <0.1 Functional Configuration of Display Device>

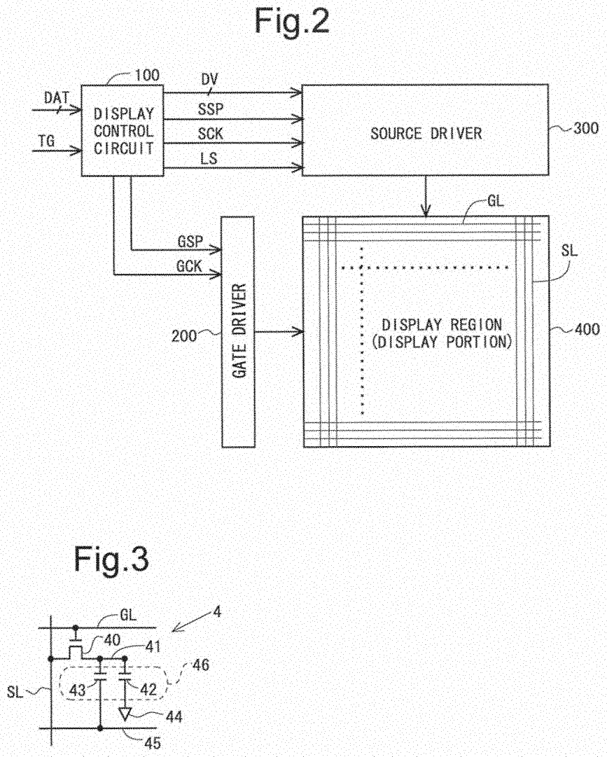

Prior to describing embodiments, matters that are common to all embodiments will be described. FIG. 2 is a block diagram showing a functional configuration of a liquid crystal display device in all embodiments. It should be noted that since FIG. 2 is a diagram for showing a functional configuration, the shape of each component and the positional relationship between the components are different from actual ones. As shown in FIG. 2, this liquid crystal display device includes a display control circuit 100, gate driver 200, source driver 300, and a display region (display portion) 400.

In the display region 400, a plurality of source bus lines (video signal lines) SL and a plurality of gate bus lines (scanning signal lines) GL are arranged. In the display region 400, pixel formation portions that form pixels are provided at intersections of the source bus lines SL and the gate bus lines GL. FIG. 3 is a circuit diagram showing a configuration of one pixel formation portion 4. The pixel formation portion 4 includes: a pixel TFT (a thin film transistor) 40 that is a switching element in which a gate terminal is connected to the gate bus line GL passing through a corresponding intersection and a source terminal is connected to the source bus line SL passing through the intersection; a pixel electrode 41 connected to a drain terminal of the pixel TFT 40; a common electrode 44 and an auxiliary capacitance electrode 45 which are commonly provided to a plurality of the pixel formation portions 4 formed in the display region 400; a liquid crystal capacitance 42 formed of the pixel electrode 41 and the common electrode 44; and an auxiliary capacitance 43 formed of the pixel electrode 41 and the auxiliary capacitance electrode 45. The liquid crystal capacitance 42 and the auxiliary capacitance 43 constitute a pixel capacitance 46. Note that, the configuration of the pixel formation portion 4 is not limited to the configuration shown in FIG. 3. For example, a configuration in which the auxiliary capacitance 43 and the auxiliary capacitance electrode 45 are not provided can also be adopted.

Meanwhile, in the following embodiments, for the pixel TFT 40, a thin film transistor using an oxide semiconductor as a semiconductor layer (an oxide semiconductor TFT) is adopted. In addition, for thin film transistors in the gate driver 200 (thin film transistors included in each unit circuit 2 in a shift register 20 which will be described later), likewise, the oxide semiconductor TFT is adopted. Examples of the oxide semiconductor TFT include a thin film transistor having an oxide semiconductor layer including an In—Ga—Zn—O-based semiconductor (IGZO-TFT). Note, however, that for materials of the semiconductor layer of the thin film transistor, various variations are applicable. In addition to the thin film transistor using an oxide semiconductor as a semiconductor layer, for example, a thin film transistor using amorphous silicon as a semiconductor layer (a-Si TFT), a thin film transistor using microcrystalline silicon as a semiconductor layer, a thin film transistor using low-temperature polysilicon as a semiconductor layer (LTPS-TFT), etc. can be adopted.

It should be noted that since the oxide semiconductor has high electron mobility, decrease in size of TFT (switching element) can be realized and advantageous effects are obtained in terms of high definition and high aperture ratio by using the oxide semiconductor TFT such as the IGZO-TFT. In addition, since the leakage current is reduced, an advantageous effect is obtained in terms of low power consumption. Further, by using the oxide semiconductor TFT as the pixel TFT 40 as described above, the voltage holding ratio of the pixel is increased.

Hereinafter, operations of the components illustrated in FIG. 2 will be described. The display control circuit 100 receives an image signal DAT and a timing signal group TG such as a horizontal synchronization signal and a vertical synchronization signal, which are sent from an external source, and outputs a digital video signal DV, a gate start pulse signal (scan start signal) GSP and a gate clock signal GCK for controlling an operation of the gate driver 200, and a source start pulse signal SSP, a source clock signal SCK and a latch strobe signal LS for controlling an operation of the source driver 300.

The gate driver 300 repeats application of an active scanning signal to each of the gate bus lines GL with one vertical scanning period as a cycle based on the gate start pulse signal GSP and the gate clock signal GCK, which are sent from the display control circuit 100.

The source driver 300 receives the digital video signal DV, the source start pulse signal SSP, the source clock signal SCK and the latch strobe signal LS, which are sent from the display control circuit 100, and applies driving video signals to the source bus lines SL. At this time, the source driver 300 sequentially holds the digital video signals DV, which indicate voltages to be applied to the respective source bus lines SL, at pieces of timing when pulses of the source clock signal SCK are generated. Then, the held digital video signals DV are converted to analog voltages at a timing when a pulse of the latch strobe signal LS is generated. The converted analog voltages are simultaneously applied as the driving video signals to all the source bus lines SL.

As described above, the scanning signals are applied to the gate bus lines GL and the driving video signals are applied to the source bus lines SL, whereby an image corresponding to the image signal DAT sent from the external source is displayed on the display region (display portion) 400.

<0.2 Gate Driver>

Next, the gate driver 200 will be described. It should be noted that a configuration described here is an example, and other configurations may be adopted. In the following embodiments, the gate driver 200 is configured by a shift register arranged at one end side of the display region 400 (hereinafter referred to as a “first shift register”) and a shift register arranged at the other end side of the display region 400 (hereinafter referred to as a “second shift register”). The first shift register is given reference character 20(1) and the second shift register is given reference character 20(2). The first shift register 20(1) drives the gate bus lines GL of the odd-numbered rows from one end side of the display region 400. The second shift register 20(2) drives the gate bus lines GL of the even-numbered rows from the other end side of the display region 400. The first shift register 20(1) and the second shift register 20(2) have the same configuration. However, given signals are different for the first shift register 20(1) and the second shift register 20(2). In the following embodiments, each shift register operates based on two-phase or four-phase gate clock signals GCK. That is, four-phase or eight-phase gate clock signals GCK are used as a whole.

<0.2.1 Configuration of Shift Register>

<0.2.1.1 Case in which Two-Phase Gate Clock Signals are Used>

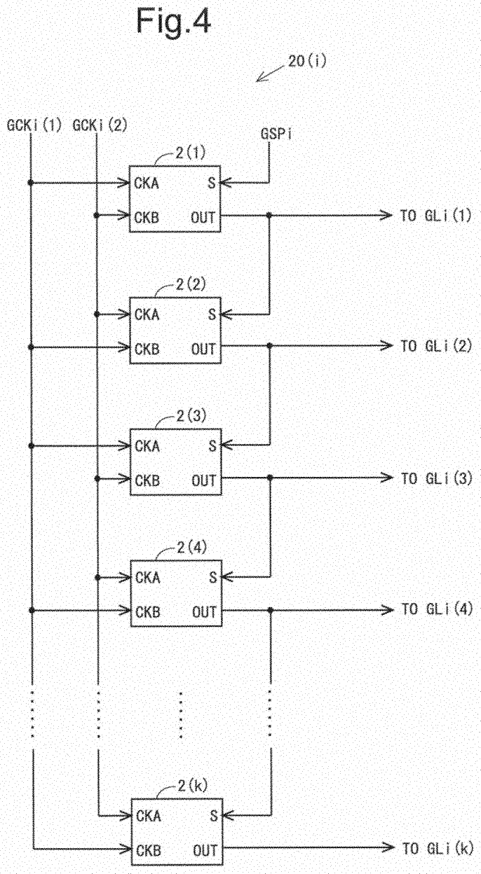

FIG. 4 is a block diagram showing a schematic configuration of the shift register 20(1) for a case in which two-phase gate clock signals are used. Since the first, shift register 20(1) and the second shift register 20 (2) have the same configuration as described above, here, both will be described together. It is assumed that each shift register 20(i) is connected to k gate bus lines GLi(1) to GLi(k).

As shown in FIG. 4, the shift register 20(i) includes k unit circuits 2(1) to 2(k) (k is a natural number). These k unit circuits 2(1) to 2(k) are connected in series with one another. Each unit circuit 2 is provided with an input terminal for receiving a first clock CKA, an input terminal for receiving a second clock CKB, an Input terminal for receiving a set signal 5, and an output terminal for outputting an output signal OUT. Although each unit circuit 2 is also provided with an input terminal for initialization signal INIT, an input terminal for a low-level power supply voltage VSS, and an input terminal for a high-level power supply voltage VDD, these input terminals are omitted in FIG. 4. It should be noted that, in the following, the magnitude of the potential given based on the low-level power supply voltage VSS is referred to as “VSS potential”, for convenience.

A gate start pulse signal GSPi and two-phase gate clock signals GCKi(1) and GCKi(2) are supplied to this shift register 20(i). Signals supplied to the input terminals of each stage (each unit circuit 2) of the shift register 20(i) are as follows (see FIG. 4). As for the odd-numbered stages, the gate clock signal GCKi(1) is supplied as the first clock CKA, and the gate clock signal GCKi(2) is supplied as the second clock CKB. As for the even-numbered stages, the gate clock signal GCKi(2) is supplied as the first clock CKA, and the gate clock signal GCKi(1) is supplied as the second clock CKB. It should be noted that phases of the gate clock signal GCKi(1) and the gate clock signal GCKi(2) are displaced by 180 degree. In addition, as for any stage, the output signal OUT outputted from the preceding stage is supplied as the set signal S. However, as for the unit circuit 2(1) of the first stage, the gate start pulse signal GSPi is supplied as the set signal S.

An output signal OUT is outputted from the output, terminal of each stage (each unit circuit 2) of the shift register 20(i). The output signal OUT outputted from any stage (here, z-th stage) is supplied as the set signal S to the unit circuit 2(z+1) of the (z+1)-th stage in addition to being supplied as the scanning signal to the z-th gate bus line GLi (z) of the K gate bus lines which are connected to this shift register 20(i).

In a configuration such as that described above, when a pulse of the gate start pulse signal GSPi serving as the set signal S is supplied to the unit circuit 2(1) of the first stage of the shift register 20(i), a shift pulse included in the output signal OUT outputted from each unit circuit 2 is sequentially transferred from the unit circuit 2(1) of the first stage to the unit circuit 2(k) of the k-th stage, based on clock operation of the two-phase gate clock signals GCKi(1) and GCKi(2). Then, in response to the transfer of the shift pulse, the output signals OUT outputted from the respective unit circuits 2 sequentially become the high level. By this, scanning signals that sequentially become the high level for a predetermined period are supplied to the k gate bus lines GLi(1) to GLi(k) which are connected to this shift register 20(i).

<0.2.1.2 Case in which Four-phase Gate Clock Signals are Used>

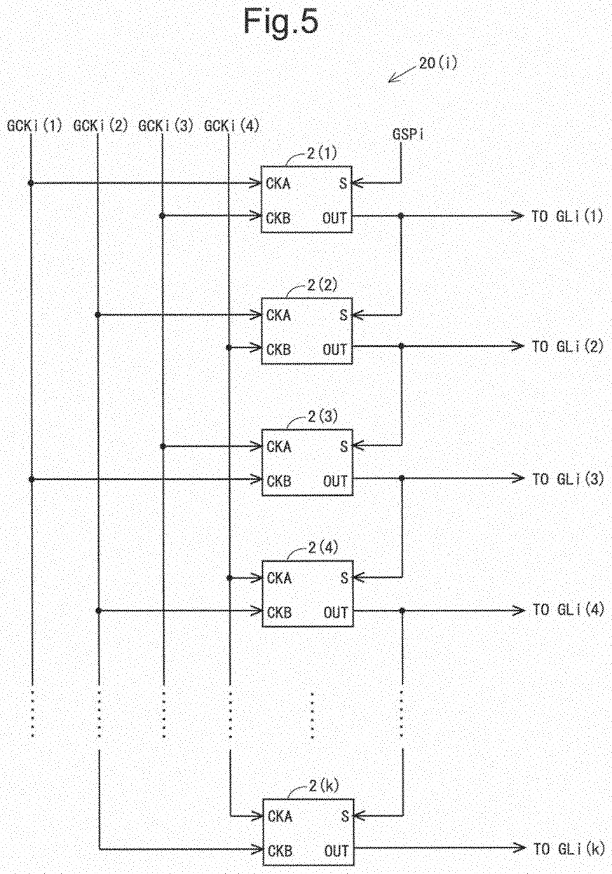

FIG. 5 is a block diagram showing a schematic configuration of the shift register 20(i) for a case in which four-phase gate clock signals are used. A gate start pulse signal GSPi and four-phase gate clock signals GCKi(1) to GCKi (4) are supplied to this shift register 20(i). Signals supplied to the input terminals of each stage (each unit circuit 2) of the shift register 20(i) are as follows (see FIG. 5). As for the unit circuit 2(1) of the first stage, the gate clock signal GCKi(1) is supplied as the first clock CKA, and the gate clock signal GCKi(3) is supplied as the second clock CKB. As for the unit circuit 2(2) of the second stage, the gate clock signal GCKi(2) is supplied as the first clock CKA, and the gate clock signal GCKi(4) is supplied as the second clock CKB. As for the unit circuit 2(3) of the third stage, the gate clock signal GCKi(3) is supplied as the first clock CKA, and the gate clock signal GCKi(1) is supplied as the second clock CKB. As for the unit circuit 2(4) of the fourth stage, the gate clock signal GCKi(4) is supplied as the first clock CKA, and the gate clock signal GCKi(2) is supplied as the second clock CKB. Such a configuration is repeated every four stages. Other points are the same as the case in which the two-phase gate clock signals GCK are used.

<0.2.2 Configuration of the Unit Circuit>

Next, the configuration of the unit circuit 2 will be described. In general, one of the drain and source that has a higher potential is called a drain, but in the description of this specification, one is defined as a drain and the other as a source, and thus, a source potential may be higher than a drain potential.

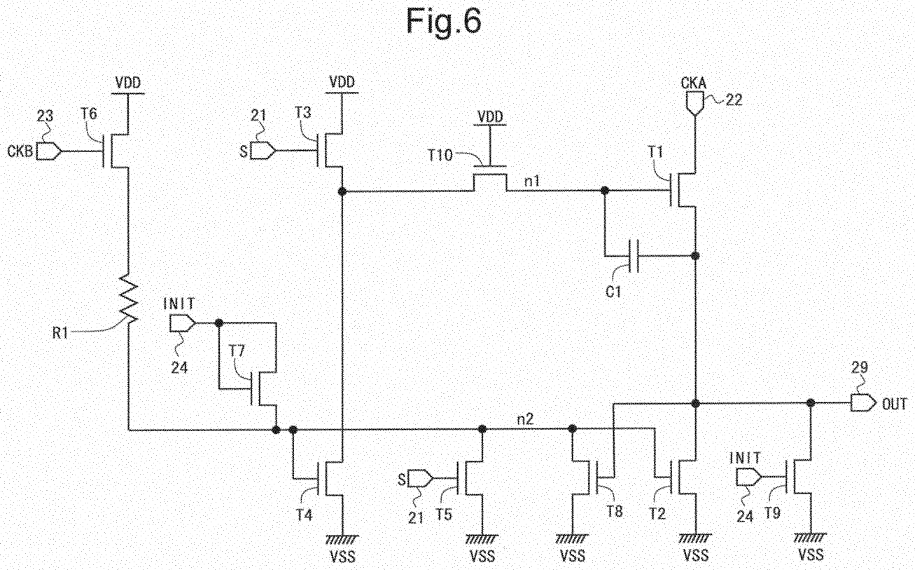

FIG. 6 is a circuit diagram showing one example of a configuration of a unit, circuit 2 constituting the shift register 20(i). As shown in FIG. 6, this unit circuit 2 includes ten thin film transistors T1 to T10, one capacitor C1, and one resistor R1. Moreover, this unit circuit 2 has four input terminals 21 to 24 and one output terminal 29, in addition to an input terminal for the low-level power supply voltage VSS and an input terminal for the high-level power supply voltage VDD. Here, an input terminal that receives the set signal S is given reference character 21, an input terminal that receives the first clock CKA is given reference character 22, an input terminal that receives the second clock CKB is given reference character 23, and an input terminal that receives the initialization signal INIT is given reference character 24. It should be noted that although the set signal S is supplied to both a gate terminal of the thin film transistor T3 and a gate terminal of the thin film transistor T5, FIG. 6 separately shows the input terminals 21 for the set signal S for convenience sake. Likewise, although the initialization signal INIT is supplied to a gate terminal of the thin film transistor T7, a drain terminal of the thin film transistor T7, and a gate terminal of the thin film transistor T9, FIG. 6 separately shows the input terminals 24 for the initialization signal INIT for convenience sake.

Next, a connection relationship between components in the unit circuit 2 will be described. The gate terminal of the thin film transistor T1, the source terminal of the thin film transistor T10, and one end of the capacitor C1 are connected to each other. Note that a region (wiring line) where they are connected to each other is referred to as a “first node” for convenience sake. The first node is given reference character n1. The gate terminal of the thin film transistor T2, the gate terminal of the thin film transistor T4, the drain terminal of the thin film transistor T5, the source terminal of the thin film transistor T7, the drain terminal of the thin film transistor T8, and one end of the resistor R1 are connected to each other. Note that a region (wiring line) where they are connected to each other is referred to as a “second node” for convenience sake. The second node is given reference character n2.

The thin film transistor T1 is connected at its gate terminal to the first node n1, connected at its drain terminal to the input terminal 22, and connected at its source terminal to the output terminal 29. The thin film transistor T2 is connected at its gate terminal to the second node n2, connected at its drain terminal to the output terminal 29, and connected at its source terminal to the input terminal for the low-level power supply voltage VSS. The thin film transistor T3 is connected at its gate terminal to the input terminal 21, connected at its drain terminal to the input terminal for the high-level power supply voltage VDD, and connected at its source terminal to the drain terminal of the thin film transistor T4 and the drain terminal of the thin film transistor T10. The thin film transistor T4 is connected at its gate terminal to the second node n2, connected at its drain terminal to the source terminal of the thin film transistor T3 and the drain terminal of the thin film transistor T10, and connected at its source terminal to the input terminal for the low-level power supply voltage VSS. The thin film transistor T5 is connected at its gate terminal to the input terminal 21, connected at its drain terminal to the second node n2, and connected at its source terminal to the input terminal for the low-level power supply voltage VSS.

The thin film transistor T6 is connected at its gate terminal to the input terminal 23, connected at its drain terminal to the input terminal for the high-level power supply voltage VDD, and connected at its source terminal to the other end of the resistor R1. The thin film transistor T7 is connected at its gate terminal and its drain terminal to the input terminal 24, and connected at its source terminal to the second node n2. The thin film transistor T8 is connected at its gate terminal to the output terminal 29, connected at its drain terminal to the second node n2, and connected at its source terminal to the input terminal for the low-level power supply voltage VSS. The thin film transistor T9 is connected at its gate terminal to the input terminal 24, connected at its drain terminal to the output terminal 29, and connected at its source terminal to the input terminal for the low-level power supply voltage VSS. The thin film transistor T10 is connected at its gate terminal to the input terminal for the high-level power supply voltage VDD, connected at its drain terminal to the source terminal of the thin film transistor T3 and the drain terminal of the thin film transistor T4, and connected at its source terminal to the first node n1.

The capacitor C1 is connected at its one end to the gate terminal of the thin film transistor T2 and connected at its other end to the source terminal of the thin film transistor T1. The resistor R1 is connected at its one end to the second node n2 and connected at its other end to the source terminal of the thin film transistor T6.

<0.2.3 Operation of Shift Register>

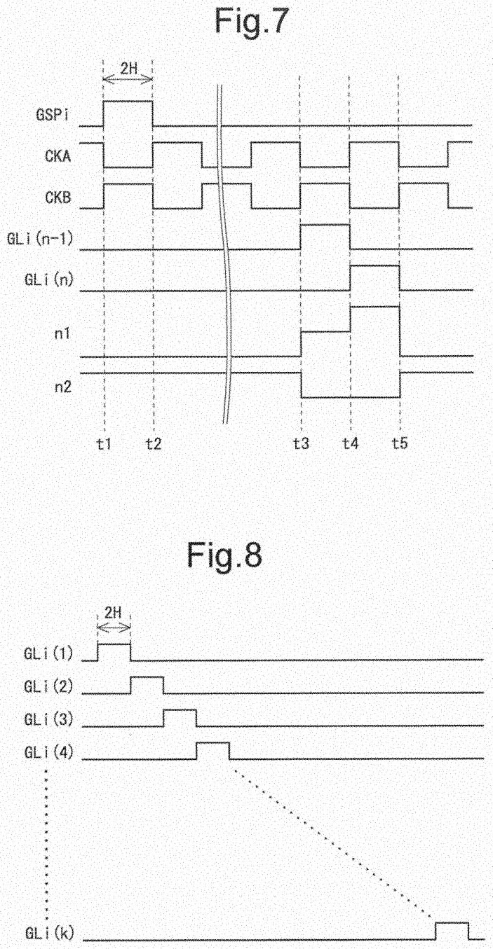

Next, with reference to FIG. 4, FIG. 6, FIG. 7, and FIG. 8, an operation of the shift register 20(i) for a case in which two-phase gate clock signals are used will be described. Here, the unit circuit 2(n) of the n-th stage of the shift register 20(i) is focused on FIG. 7 is a signal waveform diagram for describing an operation of the unit circuit 2(n) of the n-th stage. It should be noted that, for convenience, a scanning signal supplied to each gate bus line is given the same reference character as the corresponding gate bus line.

In the following embodiments, the pulse width of the above-described two-phase gate clock signals GCKi(1) and GCKi(2) is set to a length of two horizontal scanning periods (twice the length of one horizontal scanning period). Accordingly, the pulse width of each of the first clock CKA and the second clock CKB supplied to the unit circuit 2(n) of the n-th stage is equal to a length of two horizontal scanning periods. The pulse width of the gate start pulse signal GSPi is also set to a length of two horizontal scanning periods (twice the length of one horizontal scanning period).

During a period before time point t1, the scanning signal GLi(n−1) is at the low level, the scanning signal GLi(n) is at the low level, the potential of the first node n1 is at the low level, and the potential of the second node n2 is at the high level. During a period from time point t1 to time point t2, a pulse of the gate start pulse signal GSPi is outputted. By this, the shift operation in the shift register 20 (i) is started.

When time point t3 comes, the scanning signal GLi(n−1) becomes the high level. Since the scanning signal GLi(n−1) is supplied as the set signal S to the unit circuit 2(n) of the n-th stage, the thin film transistor T3 and the thin film transistor T5 become the ON state in the unit circuit 2(n) of the n-th stage. By the thin film transistor T5 becoming the ON state, the potential of the second node n2 becomes the low level. Thus, the thin film transistor T2 and the thin film transistor T4 become the OFF state. At this time, since the thin film transistor T10 is in the ON state, the first node n1 is precharged due to the thin film transistor T3 becoming the ON state.

When time point t4 comes, the scanning signal GLi(n−1) (set signal S) becomes the low level. Accordingly, the thin film transistor T3 and the thin film transistor T5 become the OFF state. Further, at the time point t4, the second clock CKB changes from the high level to the low level. Accordingly, the thin film transistor T6 becomes the OFF level. Therefore, the second node n2 is maintained at the low level, and the thin film transistor T4 is maintained at the OFF state. From the above, when the time point t4 comes, the first node n1 becomes the floating state.

Further, at the time point t4, the first clock CKA changes from the low level to the high level. Accordingly, the potential of the input terminal 22 rises. Since the first node n1 is in the floating state as described above, the first node n1 is bootstrapped by an increase in the potential of the input terminal 22. As a result, a high voltage is applied to the gate terminal of the thin film transistor T1, and a potential of the output signal OUT (a potential of the output terminal 29) increases up to the high-level potential of the first clock CKA without causing a so-called threshold voltage drop (where the source potential increases only up to a potential lower than the drain potential by the threshold voltage). That is, at the time point t4, the scanning signal GLi(n) becomes the high level.

Furthermore, at the time point t4, by the output signal OUT becoming the high level in the manner described above, the thin film transistor T8 becomes the ON state. Thus, the potential of the second node n2 are surely led to the VSS potential. Accordingly, at the time point t4, the thin film transistor T2 and the thin film transistor T4 are surely maintained at the OFF state. Therefore, during a period from the time point t4 to time point t5, a decrease in the potential of the output signal OUT (that is, the potential of the scanning signal GLi(n)) and a decrease in the potential of the first node n1 do not occur.

When the time point t5 comes, the first clock CKA changes from the high level to the low level. Accordingly, the potential of the output signal OUT (the potential of the output terminal 29) becomes the low level with a decrease in the potential of the input terminal 22. In addition, with a decrease in the potential of the output terminal 29, the potential of the first node n1 decreases through the capacitor C1. Further, at the time point t5, the second clock CKB changes from the low level to the high level. Accordingly, the thin film transistor T6 becomes the ON state. As a result, since the potential of the second node n2 rises from the low level to the high level through the resistor R1, the thin film transistor T2 and the thin film transistor T4 become the ON state Accordingly, the potential of the output signal OUT (that is, the potential of the scanning signal GLi(n)) and the potential of the first node n1 are led to the VSS potential.

By performing the above operation in each unit circuit 2, scanning signals GLi(1) to GLi(k) that sequentially become the high level for two horizontal scanning periods as shown in FIG. 8 are supplied to the k gate bus lines connected to this shift register 20(i).

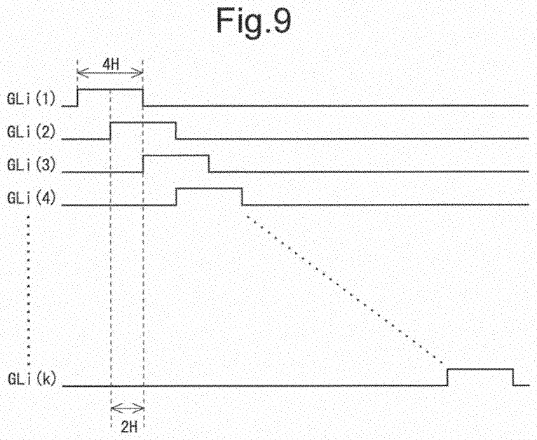

It should be noted that, in a case in which the shift register 20(i) operates based on the four-phase gate clock signals GCK, each of the pulse width of the four-phase gate clock signals GCK and the pulse width of the gate start pulse signal GSP is set to a length of four horizontal scanning periods (four times the length of one horizontal scanning period). Then, scanning signals GLi(1) to GLi(k) that sequentially become the high level for four horizontal scanning periods as shown in FIG. 9 are supplied to the k gate bus lines connected to the shift register 20(i). However, as grasped from FIG. 9, a period in which the scanning signal GLi(p) (p is an integer not less than one and not more than k−1) is maintained at the high level and a period in which the scanning signal GLi(p+1) is maintained at the high level overlap for two horizontal scanning periods.

<0.3 Features>

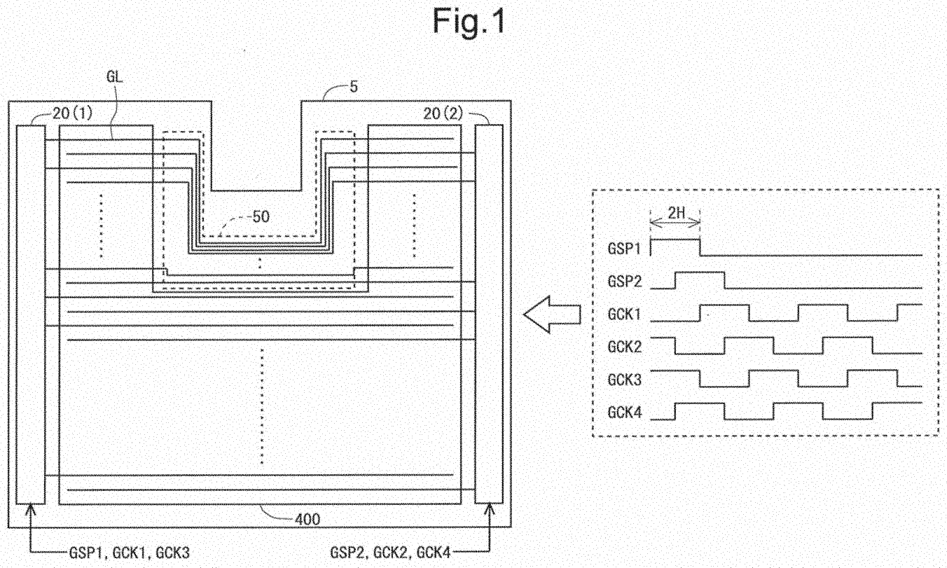

Next, features that are common to all embodiments will be described with reference to FIG. 1. The liquid crystal display device includes a panel substrate 5. In the panel substrate 5, a display region 400 in which a plurality of gate bus lines GL are arranged and a gate driver including a first shift register 20(1) and a second shift register 20(2) are formed. The gate bus lines GL are arranged on the panel substrate 5. In this regard, in some regions, the wiring pitch between adjacent gate bus lines GL is narrow. In other words, when two adjacent gate bus lines GL are defined as a “gate bus line pair”, on the panel substrate 5, there are a wide region where the wiring pitch between two gate bus lines constituting the gate bus line pair is relatively wide and the narrow region where the wiring pitch between the two gate bus lines constituting the gate bus line pair is relatively narrow. In the example of FIG. 1, a region indicated by reference character 50 is the narrow region. In the liquid crystal display device having such a narrow region, the gate driver 200 (the first shift register 20(1) and the second shift register 20(2)) operates based on the gate start pulse signal GSP and the gate clock signals GCK that have a pulse width corresponding to N (N is an integer not less than two) times the length of one horizontal scanning period. Here, a generation period of a pulse of a gate clock signal GCK supplied to a unit circuit 2 corresponding to one gate bus line GL constituting the gate bus line pair in order to bring the gate bus line concerned into the selected state and a generation period of a pulse of a gate clock signal GCK supplied to a unit circuit 2 corresponding to the other gate bus line GL constituting the gate bus line pair in order to bring the gate bus line concerned into the selected state overlap for at least one horizontal scanning period. Hereinafter, embodiments will be described.

### 1. First Embodiment

<1.1 Configuration of Main Part>

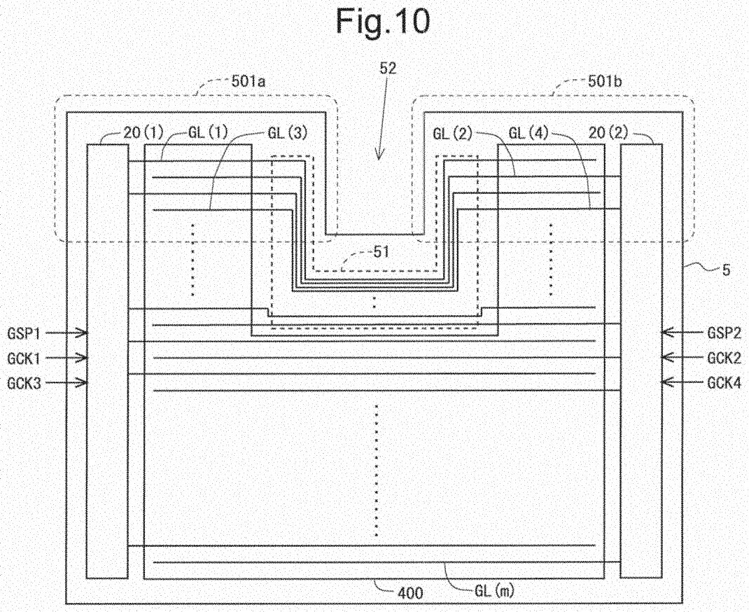

k first embodiment will be described. FIG. 10 is a diagram showing a configuration of main part of a liquid crystal display device according to the first embodiment. As shown in FIG. 10, on the panel substrate 5, the display region 400 and two shift registers (the first shift register 20(1) and the second shift register 20(2)) constituting the gate driver 200 are formed. Here, it is assumed that m gate bus lines GL(1) to GL(m) are arranged in the display region 400. The first shift register 20(1) operates based on the gate start pulse signal GSP1 and the gate clock signals GCK1 and GCK3. The second shift register 20(2) operates based on the gate start pulse signal GSP2 and the gate clock signals GCK2 and GCK4. Thus, two-phase gate clock signals GCK are used for the driving of each shift register 20.

When focusing on signals for operating the first shift register 20(1), the gate start pulse signal GSP1 corresponds to the gate start pulse signal GSPi in FIG. 4, the gate clock signal GCK1 corresponds to the gate clock signal GCKi(1) in FIG. 4, and the gate clock signal GCK3 corresponds to the gate clock signal GCKi(2) in FIG. 4. When focusing on signals for operating the second shift register 20(2), the gate start pulse signal GSP2 corresponds to the gate start pulse signal GSPi in FIG. 4, the gate clock signal GCK2 corresponds to the gate clock signal GCKi(1) in FIG. 4, and the gate clock signal GCK4 corresponds to the gate clock signal GCKi(2) in FIG. 4.

As shown in FIG. 10, a first convex part 501a and a second convex part 501b are provided in the panel substrate 5. By thus providing the first convex part 501a and the second convex part 501b, a concave part 52 is formed. Thus, the panel substrate 5 has a concave shape in a plan view. In addition, in accordance with this, the display region 400 also has a concave shape in a plan view. Since each of the panel substrate 5 arid the display region 400 has a concave shape in this manner, some gate bus lines GL are arranged so as to bypass the concave part 52. That is, some gate bus lines GL are arranged in the bypass wiring region 51 described above. It should be noted that the bypass wiring region 51 is provided in the non-display region (non-active area). In the present embodiment, the wiring pitch (the wiring pitch between adjacent gate bus lines GL) in the bypass wiring region 51 is narrower than the wiring pitch in the other regions. That is, the bypass wiring region 51 corresponds to the narrow region described above. It should be noted that, of the region where the gate bus lines GL are disposed, the region other than the narrow region is the wide region.

<1.2 Driving Method>

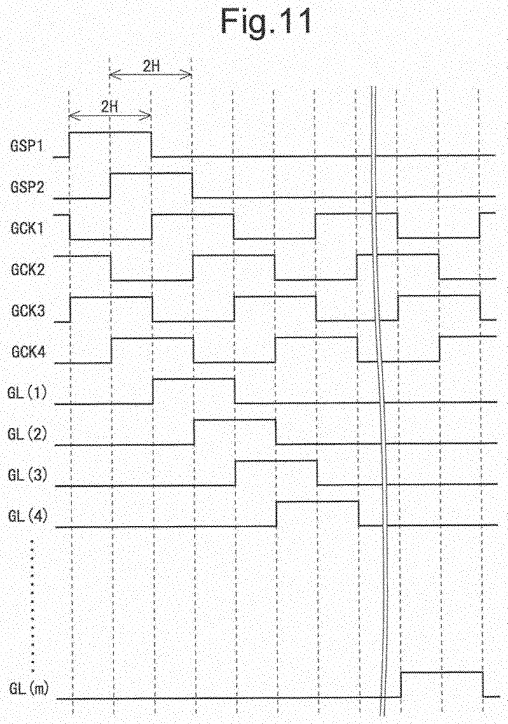

FIG. 11 is a signal waveform diagram for describing a driving method in the present embodiment. It should be noted that FIG. 11 shows ideal waveforms ignoring delay and noise. A phase of the gate clock signal GCK1 and a phase of the gate clock signal GCK2 are displaced by 180 degrees and a phase of the gate clock signal GCK2 and a phase of the gate clock signal GCK4 are displaced by 180 degrees. Further, the gate clock signal GCK2 is delayed in phase by 90 degrees relative to the gate clock signal GCK1. The pulse width of each of the gate start pulse signals GSP1 and GSP2 and gate clock signals GCK1 to GCK4 is set to a length of two horizontal scanning periods.

Under the condition as described above, the first shift register 20(1) operates based on the gate start pulse signal GSP1 and the gate clock signals GCK1 and GCK3. Thus, scanning signals sequentially becoming the high level for two horizontal scanning periods as shown in FIG. 8 are outputted from the first shift register 20(1). In addition, the second shift register 20(2) operates based on the gate start pulse signal GSP2 and the gate clock signals GCK2 and GCK4. Thus, scanning signals sequentially becoming the high level for two horizontal scanning periods as shown in FIG. 8 are also outputted from the second shift register 20(2). Here, as shown in FIG. 11, the pulse of the gate start pulse signal GSP2 is generated one horizontal scanning period after the generation timing of the pulse of the gate start pulse signal GSP1. In addition, the gate clock signal GCK1 changes from the low level to the high level two horizontal scanning periods after the generation timing of the pulse of the gate start pulse signal GSP1.

From the above, the scanning signals GL(1) to GL(m) having waveforms as shown in FIG. 11 are outputted to the m gate bus lines. As grasped from FIG. 11, the pulse of the scanning signal is outputted every one horizontal scanning period, and the pulse width of each scanning signal is equal to a length of two horizontal scanning periods. Accordingly, a generation period of a pulse of the scanning signal GL(p) of the p-th row (p is an integer not less than one and not more than m−1) and a generation period of a pulse of the scanning signal GL(p+1) of the (p+1)-th row overlap for one horizontal scanning period. Thus, scanning signals are supplied to the two adjacent gate bus lines GL in such a way that an overlapping period of pulse generation periods occurs.

<1.3 Advantageous Effect>

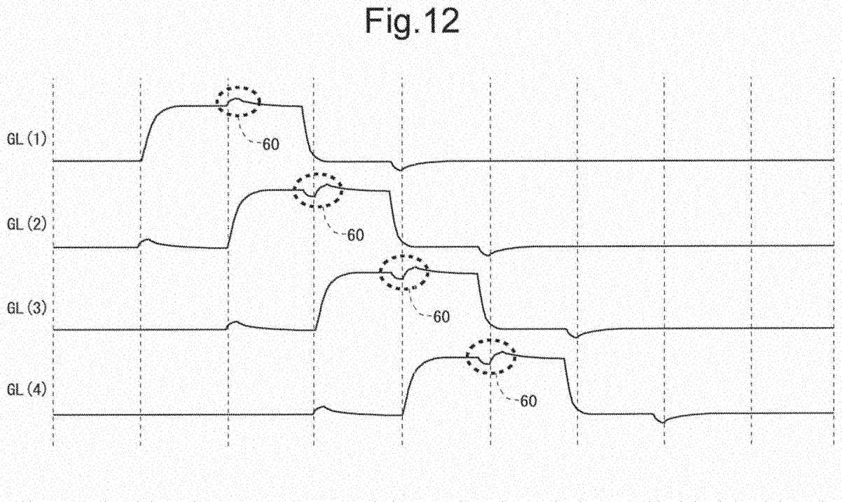

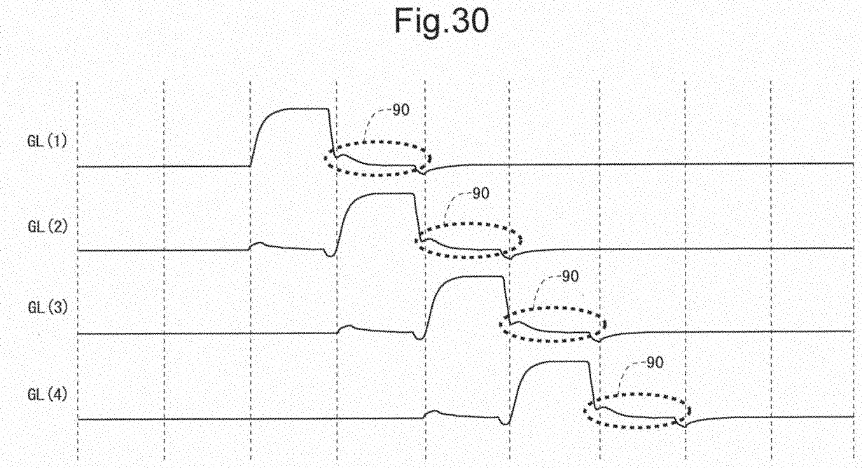

FIG. 12 is a signal waveform diagram for describing an advantageous effect in the present embodiment. It should be noted that FIG. 12 shows waveforms of scanning signals GL(1) to GL(4) of the first row to the fourth row. A portion indicated by reference character 60 in FIG. 12 is a portion in which coupling noise caused by rising of the scanning signal for the next row occurs. Conventionally, since such coupling noise occurs, in a period during which a potential of the scanning signal is maintained at the low level, the potential of the scanning signal rises temporarily (see FIG. 30), and therefore display defects occurs due to unnecessary writing to the pixel capacitance. In contrast, according to the present embodiment, in a period during which the scanning signal for each row is maintained at the high level, the scanning signal for the next row rises. Accordingly, as shown in FIG. 12, in each gate bus line GL, coupling noise occurs in a period during which the scanning signal is maintained at the high level. Therefore, even when coupling noise occurs, writing to the pixel capacitance 46 is performed based on a desired video signal. Further, in each gate bus line GL, after falling of the scanning signal, there is no influence of rising of the scanning signal for the next row. From the above, according to the present embodiment, in the liquid crystal display device having the bypass wiring region 51 where the wiring pitch between adjacent gate bus lines GL is narrow, occurrence of display defect due to coupling noise is suppressed.

### 2. Second Embodiment

<2.1 Configuration of Main Part>

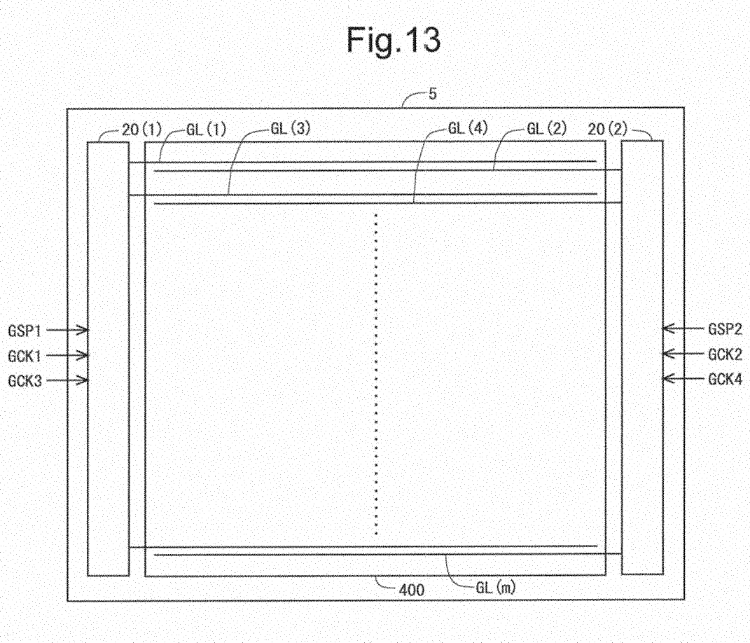

A second embodiment will be described. FIG. 13 is a diagram showing a configuration of main part of a liquid crystal display device according to the second embodiment. As in the first embodiment, on the panel substrate 5, the display region 400 and two shift registers (the first shift register 20(1) and the second shift register 20(2)) constituting the gate driver 200 are formed. The first shift register 20(1) and the second shift register 20(2) operate in the same manner as in the first embodiment.

As grasped from FIG. 13, in the present embodiment, each of the panel substrate 5 and the display region 400 has a rectangular shape in a plan view. That is, the shape of each of the panel substrate 5 and the display region 400 is the same as the shape of the conventional general liquid crystal display device. However, in the present embodiment, partially, a two-storied wiring is adopted for the wiring structure of the gate bus lines GL in the display region 400. It should be noted that the two-storied wiring is the wiring structure in which two mutually different metal layers are arranged so as to overlap in a vertical direction (a direction perpendicular to the panel substrate 5). This two-storied wiring will be described below.

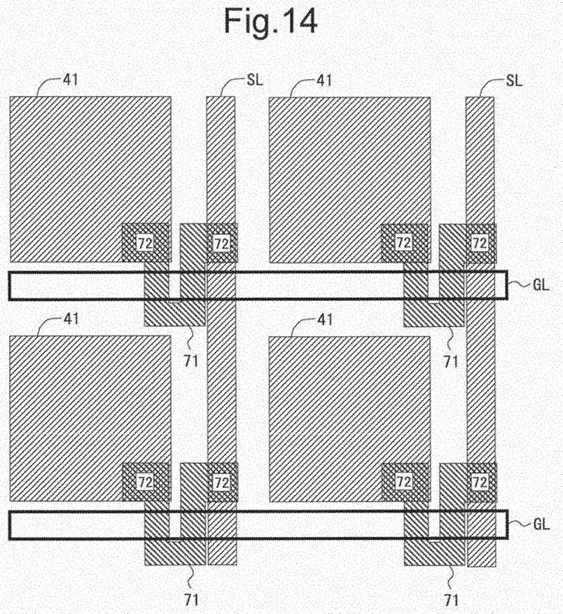

FIG. 14 is a diagram showing a general wiring structure of gate bus lines GL, etc. When focusing on the left and right direction in FIG. 14, one source bus line SL is arranged between two pixel electrodes 41. In addition, when focusing on the up and down direction in FIG. 14, one gate bus line SL is arranged between two pixel electrodes 41. A TFT having a silicon layer 71 is formed near the intersection of the gate bus line GL and the source bus line SL. A source electrode of the TFT is connected to the source bus line SL through a contact hole 72, and a drain electrode of the TFT is connected to the pixel electrode 41 through a contact hole 72.

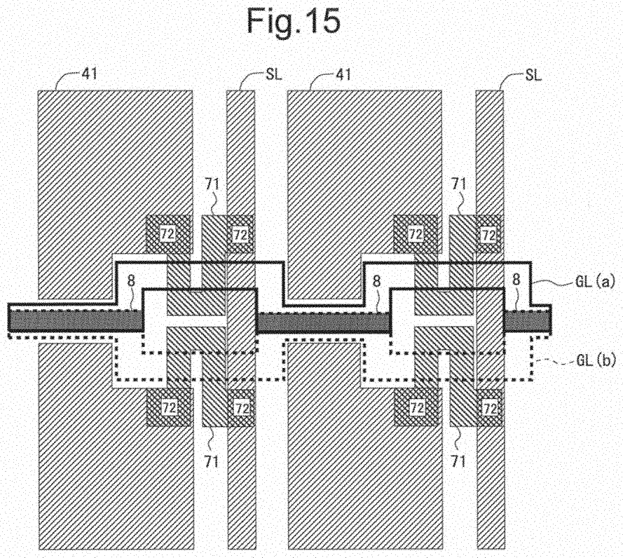

In contrast, in a case in which the two-storied wiring is adopted, the wiring structure of the gate bus lines GL, etc, is that as shown in FIG. 15. Regarding the left and right direction in FIG. 15, similarly to the example shown in FIG. 14, one source bus line SL is arranged between two pixel electrodes 41. However, regarding the up and down direction in FIG. 15, two gate bus lines GL(a) and GL(b) are arranged between two pixel electrodes 41. The gate bus line GL(a) is provided corresponding to the pixel electrode 41 disposed at an upper region in FIG. 15, and the gate bus line GL(b) is provided corresponding to the pixel electrode 41 disposed at a lower region in FIG. 15. As grasped from FIG. 15, although the wiring structure is not the two-storied wiring in the vicinity of a region where each of the gate bus lines GL(a) and GL(b) is connected to the TFT or intersects with the source bus line SL, the wiring structure is the two-storied wiring in other region. It should be noted that, :in FIG. 15, portions where the gate bus line GL(a) and the gate bus line GL(b) overlap in the vertical direction are represented by fill patterns given reference character 8.

As described above, in the present embodiment, in some regions in the display region 400, the wiring structure of the gate bus lines GL is the two-storied wiring. In a region where the wiring structure is the two-storied wiring, unlike other regions, wires (two wires as the gate bus lines GL) overlap in the vertical direction, and the wirings are in the form of the parallel flat plate. Accordingly, in a region where the wiring structure is the two-storied wiring, the coupling capacitance between the gate bus lines GL is large as in the narrow region described above.

<2.2 Driving Method>

Under the above-described configuration, the first shift register 20(1) and the second shift register 20(2) operate in the same manner as in the first embodiment. Accordingly, as in the first embodiment, the scanning signals GL(1) to GL(m) having waveforms as shown in FIG. 11 are outputted to the m gate bus lines. That is, scanning signals are supplied to two gate bus lines GL(a) and GL(b) forming the two-storied wiring in such a way that an overlapping period of pulse generation periods occurs.

<2.3 Advantageous Effects>

According to the present embodiment, in the liquid crystal display device adopting the two-storied wiring for the wiring structure of the gate bus lines GL, occurrence of display defect due to coupling noise is suppressed in the same manner as in the first embodiment. In addition, since two-storied wiring is adopted, the aperture ratio of the pixel is high. From the above, according to the present embodiment, it is possible to increase the aperture ratio of the pixel while suppressing the occurrence of the display defect due to coupling noise.

### 3. Third Embodiment

<3.1 Configuration of Main Part>

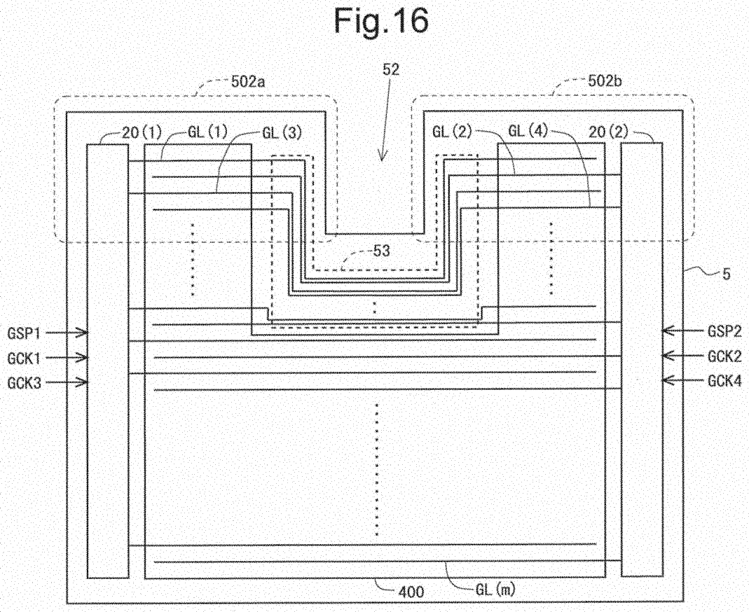

A third embodiment will be described. FIG. 16 is a diagram showing a configuration of main part of a liquid crystal display device according to the third embodiment. As in the first embodiment, on the panel substrate 5, the display region 400 and two shift registers (the first shift register 20(1) and the second shift register 20(2)) constituting the gate driver 200 are formed. The first shift register 20(1) and the second shift register 20(2) operate in the same manner as in the first embodiment.

As grasped from FIG. 16, each of the panel substrate 5 and the display region 400 has a concave shape in a plan view as in the first embodiment. Therefore, some gate bus lines GL are arranged in the bypass wiring region 53. In the present embodiment, in the bypass wiring region 53, the wiring structure of the gate bus lines GL is the two-storied wiring. Accordingly, in the bypass wiring region 53, wires (two wires as the gate bus lines GL) overlap in the vertical direction and the wirings are in the form of the parallel flat plate, and the coupling capacitance between the gate bus lines GI>is large as in the narrow region described above. It should be noted that a part given reference character 502a in FIG. 16 corresponds to the first convex part and a part given reference character 502b in FIG. 16 corresponds to the second convex part.

<3.2 Driving Method>

Under the above-described configuration, the first shift register 20(1) and the second shift register 20(2) operate in the same manner as in the first embodiment. Accordingly, as in the first embodiment, the scanning signals GL(1) to GL(m) having waveforms as shown in FIG. 11 are outputted to the m gate bus lines. That is, scanning signals are supplied to two gate bus lines GL forming the two-storied wiring in the bypass wiring region 53 in such a way that an overlapping period of pulse generation periods occurs.

<3.3 Advantageous Effects>

According to the present embodiment, in the liquid crystal display device adopting the two-storied wiring for the wiring structure of the gate bus lines GL in the bypass wiring region 53, occurrence of display defect due to coupling noise is suppressed in the same manner as in the first embodiment. In addition, by adopting the two-storied wiring in the bypass wiring region 53, it is possible to further reduce the size of the frame region.

### 4. Fourth Embodiments

<4.1 Configuration of Main Part>

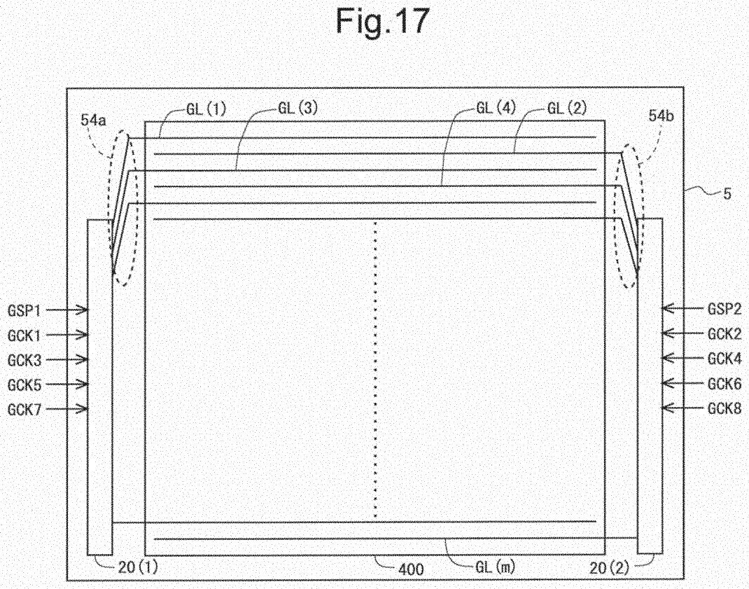

A fourth embodiment will be described. FIG. 17 is a diagram showing a configuration of main part of a liquid crystal display device according to the fourth embodiment. As shown in FIG. 17, on the panel substrate 5, the display region 400 and two shift registers (the first shift register 20(1) and the second shift register 20(2)) constituting the gate driver 200 are formed. The first shift register 20(1) operates based on the gate start pulse signal GSP1 and the gate clock signals GCK1, GCK3, GCK5, and GCK7. The second shift register 20(2) operates based on the gate start pulse signal GSP2 and the gate clock signals GCK2, GCK4, GCK6, and GCK8. Thus, four-phase gate clock signals GCK are used for the driving of each shift register 20.

When focusing on signals for operating the first shift register 20(1), the gate start pulse signal GSP1 corresponds to the gate start pulse signal GSPi in FIG. 5, the gate clock, signal GCK1 corresponds to the gate clock signal GCKi(1) in FIG. 5, the gate clock signal GCK3 corresponds to the gate clock signal GCKi(2) in FIG. 5, the gate clock signal GCK5 corresponds to the gate clock signal GCKi(3) in FIG. 5, and the gate clock signal GCK7 corresponds to the gate clock signal GCKi(4) in FIG. 5. When focusing on signals for operating the second shift register 20(2), the gate start pulse signal GSP2 corresponds to the gate start pulse signal GSPi in FIG. 5, the gate clock signal GCK1 corresponds to the gate clock signal GCKi(1) in FIG. 5, the gate clock signal GCK3 corresponds to the gate clock signal GCKi(2) in FIG. 5, the gate clock signal GCK5 corresponds to the gate clock signal GCKi(3) in FIG. 5, and the gate clock signal GCK7 corresponds to the gate clock signal GCKi(4) in FIG. 5.

As grasped from FIG. 17, while the display region 400 has a rectangular shape in a plan view, the wiring pitch in some region (regions given reference characters 54a and 54b in FIG. 17) is narrower than the wiring pitch in other region with respect to the wirings of the gate bus lines GL between the shift register 20 and the display region 400. In other words, the wiring pitch between the gate bus lines GL in part of the non-display region is narrower than that in the other region. Thus, in the present embodiment, a region 54a that is a part of the non-display region in the vicinity of one end side of the display region 400 and a region 54b that is a part of the non-display region in the vicinity of the other end side of the display region 400 correspond to the narrow region described above, and the coupling capacitance between the gate bus lines GL is large in the regions 54a and 54b.

<4.2 Driving Method>

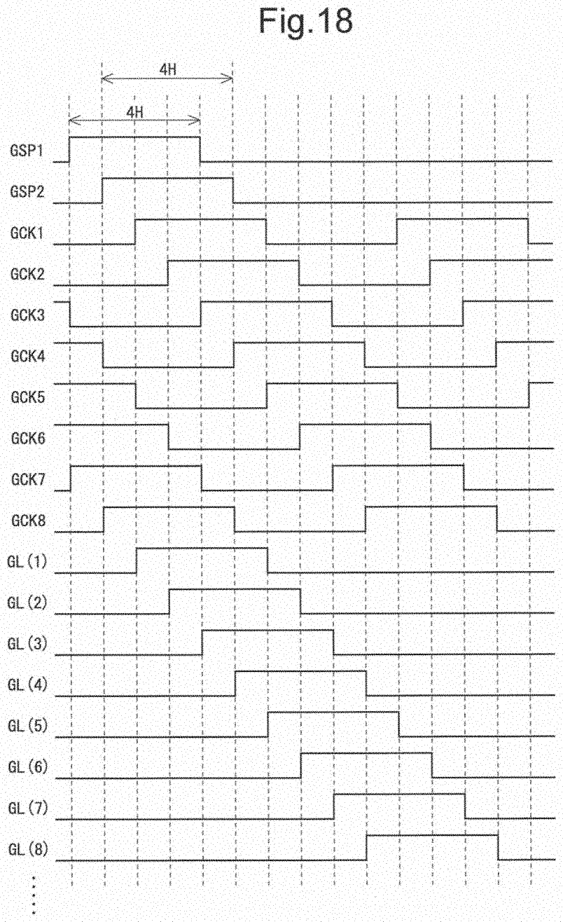

FIG. 18 is a signal waveform diagram for describing a driving method in the present embodiment. It: should be noted that FIG. 18 shows ideal waveforms ignoring delay and noise. A phase of the gate clock signal GCK1 and a phase of the gate clock signal GCK5 are displaced by 180 degrees, a phase of the gate clock signal GCK3 and a phase of the gate clock signal GCK7 are displaced by 180 degrees, and the gate clock signal GCK3 is delayed in phase by 90 degrees relative to the gate clock signal GCK1. Further, a phase of the gate clock signal GCK2 and a phase of the gate clock signal GCK6 are displaced by 180 degrees, a phase of the gate clock signal GCK4 and a phase of the gate clock signal GCK8 are displaced by 180 degrees, and the gate clock signal GCK4 is delayed in phase by 90 degrees relative to the gate clock signal GCK2. Furthermore, the gate clock signal GCK2 is delayed in phase by 45 degrees relative to the gate clock signal GCK1. The pulse width of each of the gate start pulse signals GSP1 and GSP2 and gate clock signals GCK1 to GCK8 is set to a length of four horizontal scanning periods.

Under the condition as described above, the first shift register 20(1) operates based on the gate start pulse signal GSP1 and the gate clock signals GCK1, GCK3, GCK5, and GCK7. Thus, scanning signals sequentially becoming the high level for four horizontal scanning periods as shown in FIG. 9 are outputted from the first shift register 20(1). In addition, the second shift register 20(2) operates based on the gate start pulse signal GSP2 arid the gate clock signals GCK2, GCK4, GCK6 and GCK8. Thus, scanning signals sequentially becoming the high level for four horizontal scanning periods as shown in FIG. 9 are also outputted from the second shift register 20(2). Here, as shown in FIG. 18, the pulse of the gate start pulse signal GSP2 is generated one horizontal scanning period after the generation timing of the pulse of the gate start pulse signal GSP1. In addition, the gate clock signal GCK1 changes from the low level to the high level two horizontal scanning periods after the generation timing of the pulse of the gate start, pulse signal GSP1.

From the above, the scanning signals sequentially becoming active as shown in FIG. 18 are outputted to the gate bus lines GL in the display region 400. As grasped from FIG. 18, the pulse of the scanning signal is outputted every one horizontal scanning period, and the pulse width of each scanning signal is equal to a length of four horizontal scanning periods. Here, in a region given reference character 54a in FIG. 17, the gate bus lines GL of the odd-numbered rows are arranged. For example, in the region 54a, the gate bus line GL(1) of the first row and the gate bus line GL(3) of the third row are arranged so that they are adjacent to each other. As grasped from FIG. 18, regarding two scanning signals supplied to two gate bus lines GL which are arranged so that they are adjacent to each other, generation periods of pulses overlap for two horizontal scanning periods. In the same manner, regarding two scanning signals (for example, GL(2) and GL(4) ) supplied to two gate bus lines GL which are arranged so that they are adjacent to each other in the region given reference character 54b in FIG. 17, generation periods of pulses overlap for two horizontal scanning periods as grasped from FIG. 18. Thus, scanning signals are supplied to two gate bus lines GL which are arranged so that they are adjacent to each other in the narrow region (regions given reference characters 54a and 54b in FIG. 17) in such a way that an overlapping period of pulse generation periods occurs.

<4.3 Advantageous Effects>

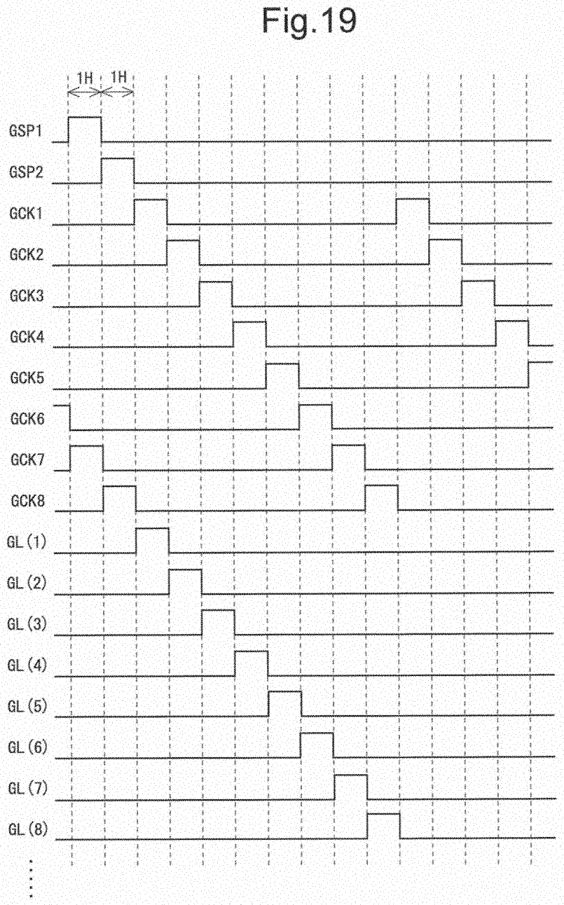

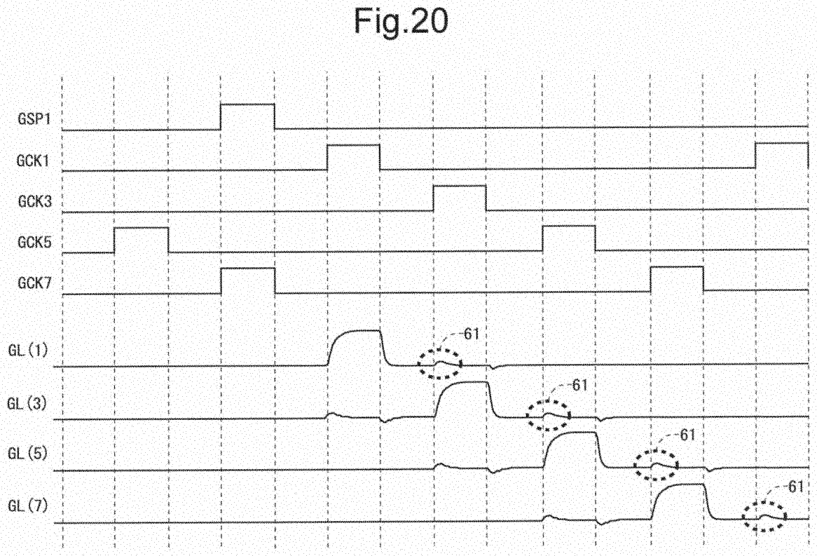

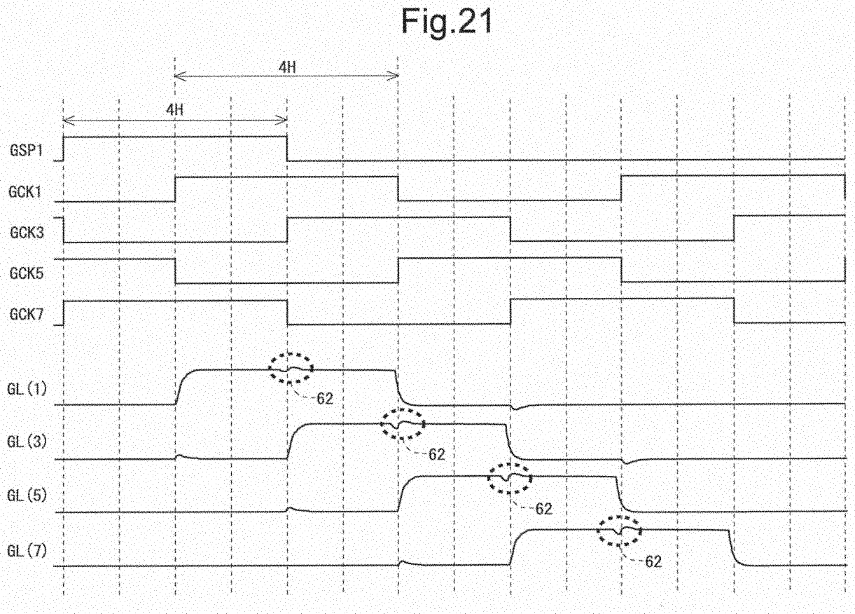

If the same driving method as conventional one is adopted in the liquid crystal display device having the configuration shown in FIG. 17, the scanning signals sequentially becoming the high level for one horizontal scanning period as shown in FIG. 19 are supplied to the m gate bus lines GL arranged on the panel substrate 5. As a result, for example, in each of the gate bus lines GL in the region given reference character 54a in FIG. 17, after falling of the scanning signal, coupling noise caused by rising of the scanning signal supplied to the adjacent gate bus line occurs as shown in portions indicated by reference character 61 in FIG. 20. Consequently, unnecessary writing to the pixel capacitance is performed and display defects occurs. In contrast, according to the present embodiment, for example, when focusing on the odd-numbered rows, in a period during which the scanning signal for each row is maintained at the high level, the scanning signal for the next row rises. Accordingly, as shown in each of portions indicated by reference character 62 in FIG. 21, in each gate bus line GL, coupling noise occurs in a period during which the scanning signal is maintained at: the high level. The same applies to the even-numbered rows. Therefore, even when coupling noise occurs, writing to the pixel capacitance 46 is performed based on a desired video signal. Further, in each gate bus line GL, after falling of the scanning signal, there is no influence of rising of the scanning signal for the subsequent rows. From the above, according to the present embodiment, in the liquid crystal display device in which the wiring pitch between adjacent gate bus lines GL is narrow in part of the non-display region (in some regions between the shift register 20 and the display region 400), occurrence of display defect due to coupling noise is suppressed.

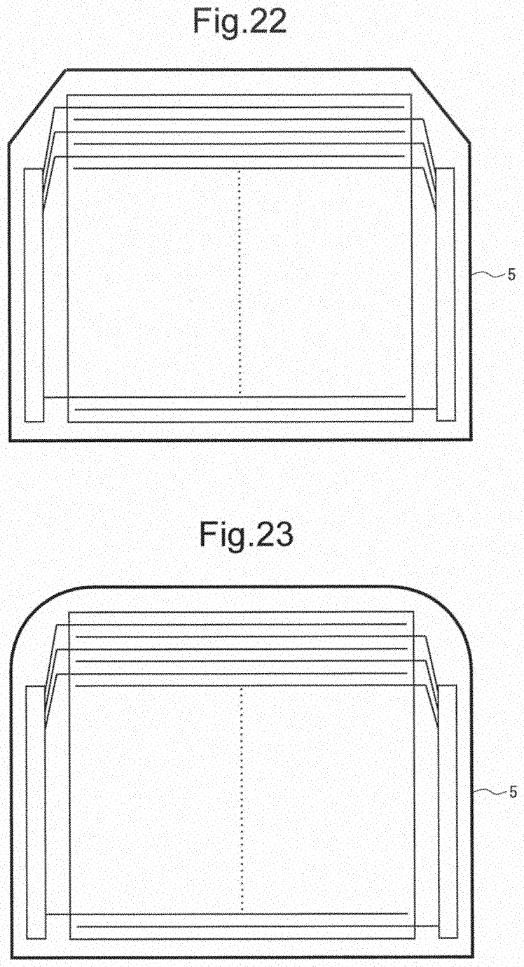

In addition, according to the present embodiment, since it is possible to narrow the wiring pitch in the non-display region, reduction in size of the outline of the panel substrate 5 and making the outline of the panel substrate 5 be an oddly shape can be achieved. For example, it is possible to make the shape of the panel substrate 5 be such a shape in which some part of corner portions (angle portions) is lacking as shown in FIG. 22 and make the corner portions of the panel substrate 5 be such a shape as an arc shape shown in FIG. 23. As described above, according to the present embodiment, it is possible to enhance the degree of freedom in the outline of the panel substrate 5 while suppressing the occurrence of the display defect due to coupling noise.

### 5. Fifth Embodiment

<5.1 Configuration of Main Part>

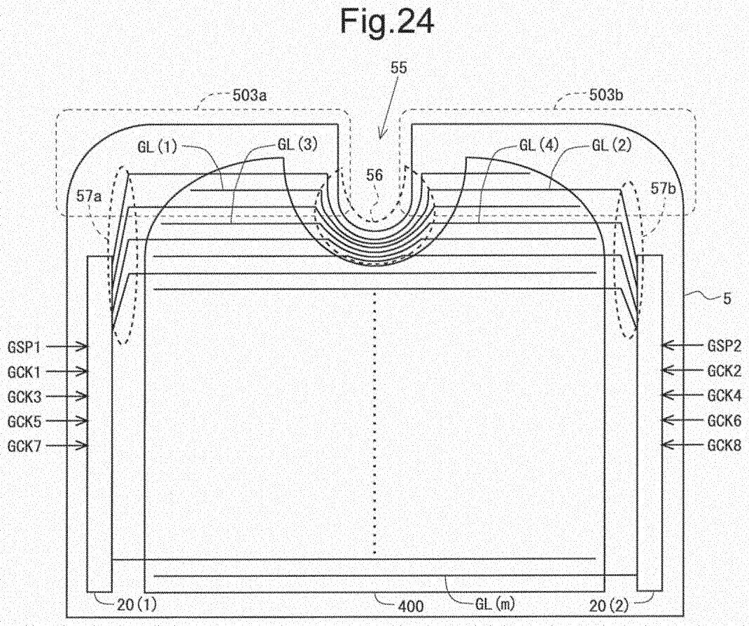

A fifth embodiment will be described. FIG. 24 is a diagram showing a configuration of main part of a liquid crystal display device according to the fifth embodiment. As shown in FIG. 24, on the panel substrate 5, the display region 400 and two shift registers (the first shift register 20(1) and the second shift register 20(2)) constituting the gate driver 200 are formed. As in the fourth embodiment, the first shift register 20(1) operates based on the gate start pulse signal GSP1 and the gate clock signals GCK1, GCK3, GCK5, and GCK7, and the second shift register 20 (2) operates based on the gate start pulse signal GSP2 and the gate clock signals GCK2, GCK4, GCK6, and GCK8.

As grasped from FIG. 24, with respect to the panel substrate 5 and the display region 400, two corner portions (angle portions) of four corner portions have arc shapes. Then, similarly to the fourth embodiment, the wiring pitch in some region (regions given reference characters 57a and 57b in FIG. 24) is narrower than the wiring pitch in other region with respect to the wirings of the gate bus lines GL between the shift register 20 and the display region 400. Further, as grasped from FIG. 24, a concave part 55 is formed in the panel substrate 5 and the display region 400, and some gate bus lines GL are arranged so as to bypass the concave part 55. That is, as in the first embodiment, some gate bus lines GL are arranged in the bypass wiring region 56. The wiring pitch (the wiring pitch between adjacent gate bus lines GL) in the bypass wiring region 56 is narrower than the wiring pitch in other regions. From the above, according to the present embodiment, a region 57a that is a part of the non-display region in the vicinity of one end side of the display region 400, a region 57b that is a part of the non-display region in the vicinity of the other end side of the display region 400, and the bypass wiring region 56 correspond to the narrow region described above, and the coupling capacitance between the gate bus lines GL is large in these regions. It should be noted that a part given reference character 503a in FIG. 24 corresponds to the first convex part and apart given reference character 503b in FIG. 24 corresponds to the second convex part.

<5.2 Driving Method>

Under the above-described configuration, the first shift register 20(1) and the second shift register 20(2) operate in the same manner as in the fourth embodiment. Accordingly, as in the fourth embodiment, the scanning signals sequentially becoming active as shown in FIG. 18 are outputted to the gate bus lines GL in the display region 400.

Here, in a region given reference character 57a in FIG. 24, the gate bus lines GL of the odd-numbered rows are arranged. For example, in the region 57a, the gate bus line GL(1) of the first row and the gate bus line GL(3) of the third row are arranged so that they are adjacent to each other. As grasped from FIG. 18, regarding two scanning signals supplied to two gate bus lines GL which are arranged so that they are adjacent to each other, generation periods of pulses overlap for two horizontal scanning periods. In the same manner, regarding two scanning signals (for example, GL(2) and GL(4)) supplied to two gate bus lines GL which are arranged so that they are adjacent to each other in the region given reference character 57b in FIG. 24, generation periods of pulses overlap for two horizontal scanning periods as grasped from FIG. 18. Furthermore, as grasped from FIG. 18, a generation period of a pulse of the scanning signal G(p) of the p-th row (p is an integer not less than one and not more than m−1) and a generation period of a pulse, of the scanning signal G(p+1) of the (p+1)-th row overlap for three horizontal scanning periods. As described above, scanning signals are supplied to two gate bus lines GL which are arranged so that they are adjacent to each other in the narrow region (regions given reference characters 57a and 57b in FIG. 17 and the bypass wiring region 56) in such a way that an overlapping period of pulse generation periods occurs.

<5.3 Advantageous Effects>

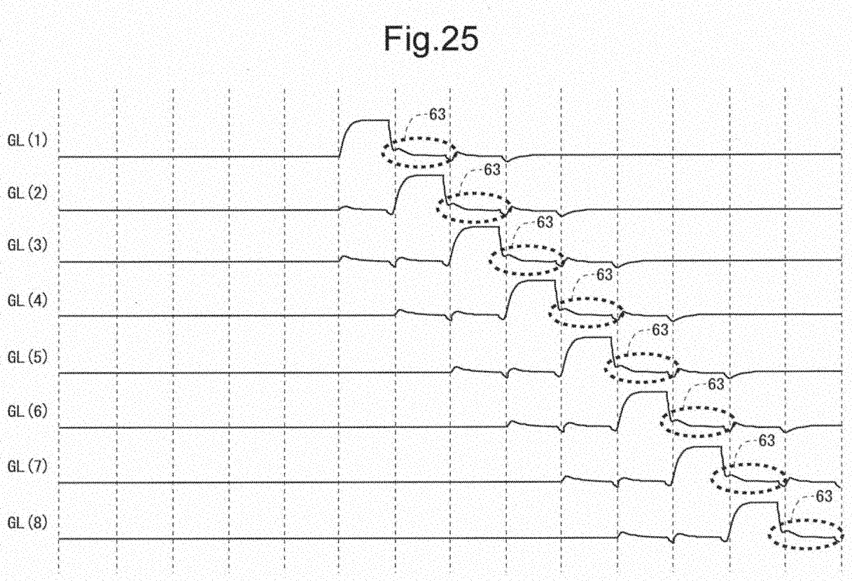

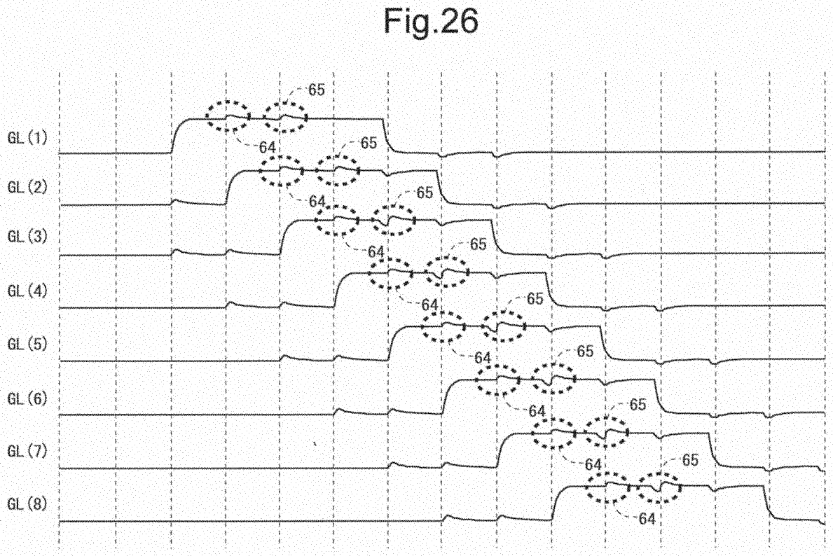

If the same driving method as conventional one is adopted in the liquid crystal display device having the configuration shown in FIG. 24, the scanning signals sequentially becoming the high level for one horizontal scanning period as shown in FIG. 19 are supplied to the m gate bus lines GL arranged on the panel substrate 5. As a result, for example, in each of the gate bus lines GL arranged in the bypass wiring region 56, after falling of the scanning signal, coupling noise caused by rising of the scanning signal for the next row occurs as shown in each of portions indicated by reference character 63 in FIG. 25. Consequently, unnecessary writing to the pixel capacitance is performed and display defects occurs. In contrast, according to the present embodiment, in a period during which the scanning signal for each row is maintained at the high level, the scanning signal for the next row rises. Accordingly, as shown in each of portions indicated by reference character 64 in FIG. 26, in each gate bus line GL, coupling noise occurs in a period during which the scanning signal is maintained at the high level. Therefore, even when coupling noise occurs, writing to the pixel capacitance 46 is performed based on a desired video signal. Further, in each gate bus line GL, after falling of the scanning signal, there is no influence of rising of the scanning signal for the next row. Further, for example, when focusing on the odd-numbered rows, in a period during which the scanning signal for each row is maintained at the high level, the scanning signal for the next row rises. Accordingly, as shown in each of portions indicated by reference character 65 in FIG. 26, in each gate bus line GL, coupling noise occurs in a period during which the scanning signal is maintained at the high level. The same applies to the even-numbered rows. Therefore, even when coupling noise occurs, writing to the pixel capacitance 46 is performed based on a desired video signal. Further, in each gate bus line GL, after falling of the scanning signal, there is no influence of rising of the scanning signal for the subsequent rows. From the above, according to the present embodiment, in the liquid crystal display device in which the bypass wiring region 56 where the wiring pitch between adjacent gate bus lines GL is narrow is provided and the wiring pitch between adjacent gate bus lines GL is narrow in part of the non-display region (in some regions between the shift register 20 and the display region 400), occurrence of display defect due to coupling noise is suppressed.

### 6. Others

The present invention is not limited to the above-described embodiments (including the variants), and can be implemented by making various modifications thereto without departing from the spirit and scope of the present invention. For example, although each of the above-described embodiments has been described by taking the liquid crystal display device as an example, the present invention can be applied to display devices other than the liquid crystal display device, such as an organic EL (Electro Luminescence) display device.

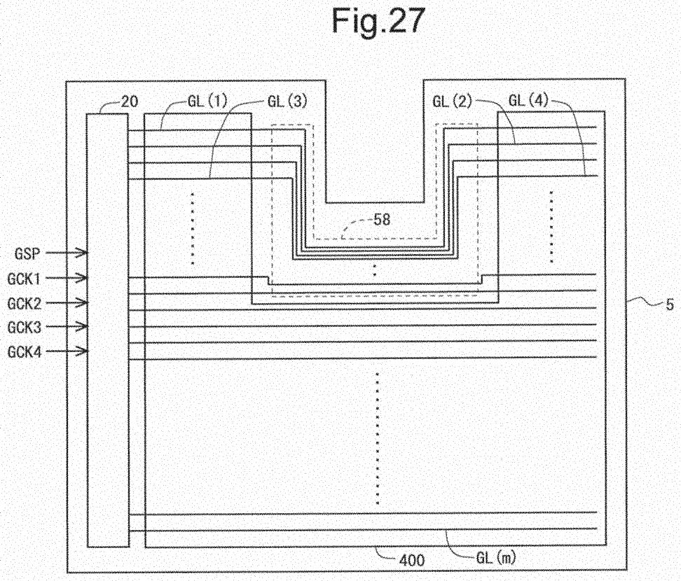

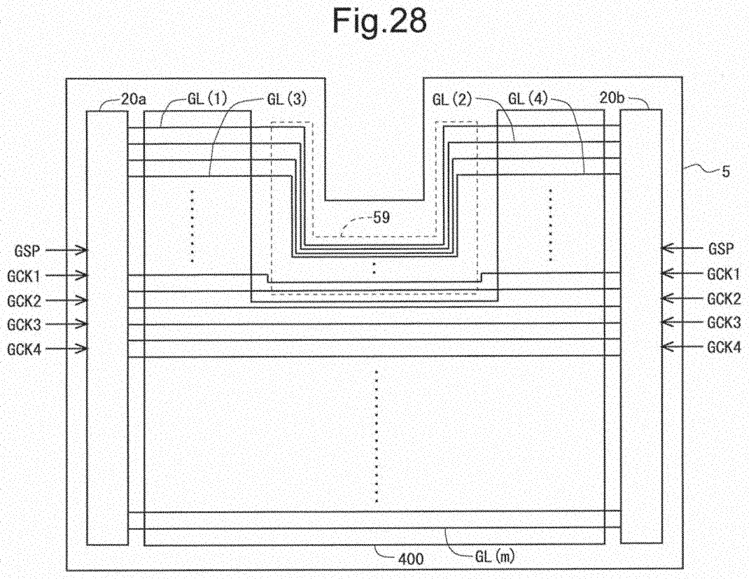

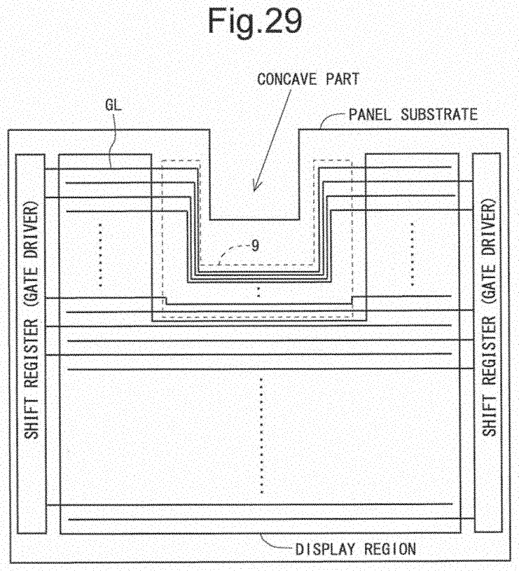

Moreover, although the shift register 20 for driving the gate bus lines GL is provided at each of one end side and the other end side of the display region 400 in each of the above embodiments, the configuration in which the shift register 20 is provided at only one end side of the display region 400 as shown in FIG. 27 may be adopted, for example, it should be noted that, in FIG. 27, a region given reference character 53 is the bypass wiring region. In the example shown in FIG. 27, by operating the shift register 20 based on the gate start pulse signal GSP and four-phase gate clock signals GCK that have a pulse width corresponding to a length of two horizontal scanning periods, scanning signals are supplied to two adjacent gate bus lines GL in such a way that an overlapping period of pulse generation periods occurs, as in the first embodiment. In this manner, also in a case in which the shift register 20 is provided at only one side of the display region 400, it is possible to suppress occurrence of display defect due to coupling noise. Further, also in a case in which the configuration is such that the shift registers (one is given reference character 20a and the other is given reference character 20b ) are provided at both end sides of the display region 400 as shown in FIG. 28 and all of the gate bus lines GL are driven from both end sides of the display region 400, it is possible to suppress occurrence of display defect due to coupling noise in the same manner.

Furthermore, although the pulse width of each of the gate start pulse signal GSP and the gate clock signals GCK is set to a length of two horizontal scanning periods in the first to third embodiments, the pulse width may be set to a length of three or more horizontal scanning periods. In addition, although the pulse width of each of the gate start pulse signal GSP and the gate clock signals GCK is set to a length of four horizontal scanning periods in the fourth and fifth embodiments, the pulse width may be set to a length of five or more horizontal scanning periods.

### 7. Notes

As display devices capable of suppressing occurrence of display defect due to coupling noise even when there is a region where the wiring pitch between adjacent gate bus lines (scanning signal lines) is narrow, the configurations described below can be considered.

### (Note 1)

A display device including a panel substrate, wherein

a display region in which a plurality of scanning signal lines are arranged and a scanning signal line drive circuit configured to drive the plurality of scanning signal lines based on a scan start signal and a plurality of clock signals are formed on the panel substrate, the scanning signal line drive circuit being configured by one or more shift register including a plurality of unit circuits,

when two adjacent scanning signal lines are defined as a scanning signal line pair, there are a wide region and a narrow region on the panel substrate, the wide region being a region where wiring interval between two scanning signal lines constituting the scanning signal line pair is relatively wide, and the narrow region being a region where wiring interval between two scanning signal lines constituting the scanning signal line pair is relatively narrow,

each of a pulse width of the scan start signal and a pulse width of the plurality of clock signals corresponds to N (N is an integer not: less than two) times a length of one horizontal scanning period, and

a generation period of a pulse of a clock signal supplied to a unit circuit corresponding to one scanning signal line constituting the scanning signal line pair in order to bring the scanning signal line concerned into a selected state and a generation period of a pulse of a clock signal supplied to a unit circuit corresponding to the other scanning signal line constituting the scanning signal line pair in order to bring the scanning signal line concerned into the selected state overlap for at least one horizontal scanning period.

### (Note 2)

The display device according to Note 1, wherein the narrow region is in a non-display region on the panel substrate.

### (Note 3)

The display device according to Note 2, wherein

the panel substrate has a concave shape in which a first convex part and a second convex part are provided such that a concave part is formed, and

a bypass wiring region is provided as the narrow region in a region between the first convex part and the second convex part, the bypass wiring region being a region where scanning signal lines are arranged so as to bypass the concave part.

### (Note 4)

The display device according to Note 3, wherein in the bypass wiring region, one scanning signal line constituting the scanning signal line pair and the other scanning signal line constituting the scanning signal line pair are arranged so as to overlap in a direction perpendicular to the panel substrate.

### (Note 5)

The display device according to Note 3, wherein each of the pulse width of the scan start signal and the pulse width of the plurality of clock signals corresponds to twice a length of one horizontal scanning period.

### (Note 6)

The display device according to Note 2, wherein

a region that is a part of the non-display region in the vicinity of one end side of the display region and a region that is a part of the non-display region in the vicinity of the other end side of the display region form the narrow region,

the scanning signal line drive circuit is configured by a first shift register configured to drive scanning signal lines of odd-numbered rows from one end side of the display region and a second shift register configured to drive scanning signal lines of even-numbered rows from the other end side of the display region, and

each of the pulse width of the scan start signal and the pulse width of the plurality of clock signals corresponds to not less than four times a length of one horizontal scanning period.

### (Note 7)

The display device according to Note 6, wherein

the panel substrate has a concave shape in which a first convex part and a second convex part are provided such that a concave part is formed, and

a bypass wiring region is provided as the narrow region in a region between the first convex part and the second convex part, the bypass wiring region being a region where scanning signal lines are arranged so as to bypass the concave part.

### (Note 3)

The display device according to Note 6, wherein each of the pulse width of the scan start signal and the pulse width of the plurality of clock signals corresponds to four times a length of one horizontal scanning period.

### (Note 9)

The display device according to Note 6, wherein a part of four corner portions of the panel substrate has an arc shape.

### (Note 10)

The display device according to Note 1, wherein a region where one scanning signal line constituting the scanning signal line pair and the other scanning signal line constituting the scanning signal line pair are arranged so as to overlap in a direction perpendicular to the panel substrate is provided as the narrow region in the display region.

### (Note 11)

The display device according to Note 10, wherein each of the pulse width of the scan start signal and the pulse width of the plurality of clock signals corresponds to twice a length of one horizontal scanning period.

### (Note 12)

A display device including a panel substrate, wherein

a display region in which a plurality of scanning signal lines are arranged and a scanning signal line drive circuit configured to drive the plurality of scanning signal lines based on a scan start signal and a plurality of clock signals are formed on the panel substrate, the scanning signal line drive circuit being configured by one or more shift register including a plurality of unit circuits,

when two adjacent scanning signal lines are defined as a scanning signal line pair, on the panel substrate, there is a region where one scanning signal line constituting the scanning signal line pair and the other scanning signal line constituting the scanning signal line pair are arranged so as to overlap in a direction perpendicular to the panel substrate,

each of a pulse width of the scan start signal and a pulse width of the plurality of clock signals corresponds to N (N is an integer not less than two) times a length of one horizontal scanning period, and

a generation period of a pulse of a clock signal supplied to a unit circuit corresponding to one scanning signal line constituting the scanning signal line pair in order to bring the scanning signal line concerned into a selected state and a generation period of a pulse of a clock signal supplied to a unit circuit corresponding to the other scanning signal line constituting the scanning signal line pair in order to bring the scanning signal line concerned into the selected state overlap for at least one horizontal scanning period.

According to the configuration described in Note 1 to Note 12 as above, when focusing on the scanning signal line pair arranged in the narrow region (or the scanning signal line pair including two scanning signal lines which are arranged so as to overlap in a vertical direction), in a period during which a scanning signal supplied to one scanning signal line is maintained at the ON level, a scanning signal supplied to the other scanning signal line changes from the OFF level to the ON level. Thus, in each scanning signal line, coupling noise occurs in a period during which the scanning signal is maintained at the ON level. Accordingly, even when coupling noise occurs, writing to the pixel capacitance is performed based on a desired video signal. Further, in each scanning signal line, after falling of the scanning signal, there is no influence of rising of the scanning signal for the adjacent row. From the above, in the display device having a region where wiring interval between adjacent scanning signal lines is narrow (or a region where two scanning signal lines are arranged so as to overlap in a vertical direction), occurrence of display defect due to coupling noise is suppressed.

### 8. Regarding Priority Claim

This application claims priority to Japanese Patent Application No. 2017-118432, entitled “Display Device”, filed Jun. 16, 2017, the content of which is incorporated herein by reference.

### DESCRIPTION OF REFERENCE CHARACTERS

2: UNIT CIRCUIT

5: PANEL SUBSTRATE

20: SHIFT REGISTER

41: PIXEL ELECTRODE

50, 51, 53, and 56: BYPASS WIRING REGION

200: GATE DRIVER (SCANNING SIGNAL LINE DRIVE CIRCUIT)

400: DISPLAY REGION (DISPLAY PORTION)

GL: GATE BUS LINE, SCANNING SIGNAL

GCK: GATE CLOCK SIGNAL

GSP: GATE START PULSE SIGNAL

1. A display device including a panel substrate, wherein
a display region in which a plurality of scanning signal lines are arranged and a scanning signal line drive circuit configured to drive the plurality of scanning signal lines based on a scan start signal and a plurality of clock signals are formed on the panel substrate, the scanning signal line drive circuit being configured by one or more shift register including a plurality of unit circuits,
when two adjacent scanning signal lines are defined as a scanning signal line pair, there are a wide region and a narrow region on the panel substrate, the wide region being a region where wiring interval between two scanning signal lines constituting the scanning signal line pair is relatively wide, and the narrow region being a region where wiring interval between two scanning signal lines constituting the scanning signal line pair is relatively narrow,
each of a pulse width of the scan start signal and a pulse width of the plurality of clock signals corresponds to N (N is an integer not less than two) times a length of one horizontal scanning period, and
a generation period of a pulse of a clock signal supplied to a unit circuit corresponding to one scanning signal line constituting the scanning signal line pair in order to bring the scanning signal line concerned into a selected state and a generation period of a pulse of a clock signal supplied to a unit circuit corresponding to the other scanning signal line constituting the scanning signal line pair in order to bring the scanning signal line concerned into the selected state overlap for at least one horizontal scanning period.

2. The display device according to claim 1, wherein the narrow region is in a non-display region on the panel substrate.

3. The display device according to claim 2, wherein
the panel substrate has a concave shape in which a first convex part and a second convex part are provided such that a concave part is formed, and
a bypass wiring region is provided as the narrow region in a region between the first convex part and the second convex part, the bypass wiring region being a region where scanning signal lines are arranged so as to bypass the concave part.

4. The display device according to claim 3, wherein in the bypass wiring region, one scanning signal line constituting the scanning signal line pair and the other scanning signal line constituting the scanning signal line pair are arranged so as to overlap in a direction perpendicular to the panel substrate.

5. The display device according to claim 3, wherein each of the pulse width of the scan start signal and the pulse width of the plurality of clock signals corresponds to twice a length of one horizontal scanning period.

6. The display device according to claim 2, wherein
a region that is a part of the non-display region in the vicinity of one end side of the display region and a region that is a part of the non-display region in the vicinity of the other end side of the display region form the narrow region,
the scanning signal line drive circuit is configured by a first shift register configured to drive scanning signal lines of odd-numbered rows from one end side of the display region and a second shift register configured to drive scanning signal lines of even-numbered rows from the other end side of the display region, and
each of the pulse width of the scan start signal and the pulse width of the plurality of clock signals corresponds to not less than four times a length of one horizontal scanning period.

7. The display device according to claim 6, wherein
the panel substrate has a concave shape in which a first convex part and a second convex part are provided such that a concave part is formed, and
a bypass wiring region is provided as the narrow region in a region between the first convex part and the second convex part, the bypass wiring region being a region where scanning signal lines are arranged so as to bypass the concave part.

8. The display device according to claim 6, wherein each of the pulse width of the scan start signal and the pulse width of the plurality of clock signals corresponds to four, times a length of one horizontal scanning period.

9. The display device according to claim 6, wherein a part of four corner portions of the panel substrate has an arc shape.

10. The display device according to claim 1, wherein a region where one scanning signal line constituting the scanning signal line pair and the other scanning signal line constituting the scanning signal line pair are arranged so as to overlap in a direction perpendicular to the panel substrate is provided as the narrow region in the display region.

11. The display device according to claim 10, wherein each of the pulse width of the scan start signal and the pulse width of the plurality of clock signals corresponds to twice a length of one horizontal scanning period.

12. A display device including a panel substrate, wherein
a display region in which a plurality of scanning signal lines are arranged and a scanning signal line drive circuit configured to drive the plurality of scanning signal lines based on a scan start signal and a plurality of clock signals are formed on the panel substrate, the scanning signal line drive circuit being configured by one or more shift register including a plurality of unit circuits,
when two adjacent scanning signal lines are defined as a scanning signal line pair, on the panel substrate, there is a region where one scanning signal line constituting the scanning signal line pair and the other scanning signal, line constituting the scanning signal line pair are arranged so as to overlap in a direction perpendicular to the panel substrate,
each of a pulse width of the scan start signal and a pulse width of the plurality of clock signals corresponds to N (N is an integer not less than two) times a length of one horizontal scanning period, and
a generation period of a pulse of a clock signal supplied to a unit circuit corresponding to one scanning signal line constituting the scanning signal line pair in order to bring the scanning signal line concerned into a selected state and a generation period of a pulse of a clock signal supplied to a unit circuit corresponding to the other scanning signal line constituting the scanning signal line pair in order to bring the scanning signal line concerned into the selected state overlap for at least one horizontal scanning period.
